(19) United States
(12) Patent Application Publication
(10) Pub. No.: US 2017/0125064 A1
(43) Pub. Date: May 4, 2017

(54) Method and Apparatus for Automatic Video Production

(71) Applicant: Seastar Labs, Inc., Jersey City, NJ (US)

(72) Inventors: Manoj Aggarwal, Lawrenceville, NJ (US); Keith J. Hanna, Bronxville, NY (US)

(21) Appl. No.: 15/342,596

(22) Filed: Nov. 3, 2016

Related U.S. Application Data
(60) Provisional application No. 62/250,186, filed on Nov. 3, 2015.
(60) Provisional application No. 62/297,977, filed on Feb. 22, 2016.
(60) Provisional application No. 62/303,944, filed on Mar. 4, 2016.
(60) Provisional application No. 62/319,371, filed on Apr. 7, 2016.

(51) Int. Cl. G11B 27/34; G06K 9/00; H04N 5/232; G11B 27/036

(52) U.S. Cl. CPC G11B 27/34; G11B 27/036; G06K 9/00744; H04N 5/23296

(57) ABSTRACT

This disclosure describes methods and systems for improving quality in video production. A video production device receives inputs from a user for only a subset of image frames presented for use in producing a video. Each of the inputs indicates a point of interest (POI) in a corresponding image frame, indicative of a region of interest for inclusion as a scene in the video. A video processor evaluates a spatial path of the indicated POIs relative to a bounding scene of interest (BSI), which represents an extent of a field of view of a corresponding camera, and dynamically adjusts the field of view to steer subsequently acquired image frames to be within the BSI. The video processor produces the video with all scenes arranged successively at a periodic interval. Use of the spatial path for scene or camera-viewpoint selection is designed to optimize quality of the produced video.

### RELATED APPLICATIONS

This application claims priority to and the benefit of U.S. Provisional Patent Application No. 62/250,186, filed Nov. 3, 2015, U.S. Provisional Patent Application No. 62/297,977, filed Feb. 22, 2016, U.S. Provisional Patent Application No. 62/303,944, filed Mar. 4, 2016, and U.S. Provisional Patent Application No. 62/319,371, filed Apr. 7, 2016, the entire content of each of which is incorporated herein by reference for all purposes.

### FIELD OF THE DISCLOSURE

The present application generally relates to video production, including but not limited to systems and methods for improving quality in video production.

### BACKGROUND

A video camera can acquire imagery containing many points of interest. Example points of interests may be basketball players, the ball, or a particular person running a marathon. More than one camera may acquire imagery of the points of interest. The multiple cameras may acquire imagery of the same points of interest at the same time from different viewpoints, such as cameras at each end of a basketball game court, or they may acquire imagery of the points of interest at different times, such as cameras positioned along a marathon course. In some applications it is useful to view a point of interest consistently over a time period. For example, for after-action review, a basketball player may only want to view close-up imagery of the player over an entire game in order to assess their performance, and a marathon runner may only want to view video of the runner as the runner completes the course.

### BRIEF SUMMARY

The present disclosure is directed towards systems and methods of improving quality in video production. Some embodiments of the present systems and methods include automatic aspects that use sparse and/or asynchronous user input for example, to determine scenes from available image frames to include in a video being produced.

In one aspect, the present disclosure is directed to a method for improving quality in video production. The method may include presenting, to a user on a display of a video production device, image frames for use in producing a video. The video being produced is to have scenes arranged successively at a periodic interval in some embodiments. Each of the presented image frames may correspond to a separate scene. A user interface of the video production device may receive inputs from the user for only a subset of the image frames. Each of the inputs may indicate a point of interest (POI) in a corresponding image frame. The POI may be indicative of a region of interest (ROI) for inclusion as a scene in the video. A video processor of the video production device may evaluate a spatial path of the indicated POIs relative to a bounding scene of interest (BSI). The BSI may represent a predetermined extent of a field of view of a corresponding camera for image frame acquisition. The video processor may dynamically adjust, in response to the evaluation, the field of view of the camera for image frame acquisition, to steer subsequently acquired image frames and corresponding scenes for the video to be contained within the BSI. The video processor may produce, in accordance with the dynamic adjustment, the video with all scenes arranged successively at the periodic interval.

In some embodiments, the camera supports spatial pan, spatial tilt and/or optical zoom functions. The BSI may at least in part be defined by capabilities of the spatial pan, spatial tilt and/or optical zoom functions. The BSI may at least in part be defined by a portion of a scene determined to be undesirable for image frame acquisition.

In certain embodiments, the camera comprises a virtual camera that uses digital pan, tilt and/or zoom functions to identify portions of high definition source images to be extracted as the image frames. The BSI may correspond to image boundaries of the high definition source images.

In particular embodiments, the camera supports spatial pan, spatial tilt, optical zoom, digital pan, digital tilt and/or digital zoom functions. The BSI may at least in part be defined by capabilities of the spatial pan, spatial tilt and/or optical zoom functions.

In some embodiments, the video processor dynamically adjusts the field of view of the camera for image frame acquisition to provide smooth spatial transition of corresponding elements across the scenes of the video. The video processor may at least one of interpolate or extrapolate, using the POIs of the subset of image frames, to identify ROIs of other image frames for inclusion as scenes in the video. The video processor may adjust, according to the spatial trajectory, one or more of the ROIs of the subset of image frames, for inclusion as one or more scenes in the video. The video processor may determine a quality metric for each of the image frames, comprising a pixel resolution of a reference POI in each of the corresponding image frames. A first number of the image frames may be acquired using a first video camera and a second number of the image frames may be acquired using a second video camera. The video processor may select a first image frame acquired using the first video camera over a second image frame acquired using the second video camera and having a same temporal position coordinate as the first image frame, to use in the video, responsive to determining that the quality metric of the first image frame is better than that of the second image frame.

In some embodiments, the video processor may determine a quality metric for each of the image frames according to at least one of a speed or direction of a reference POI with respect to a corresponding camera viewpoint. A first number of the image frames may be acquired using a first video camera and a second number of the image frames may be acquired using a second video camera. The video processor may select a first image frame acquired using the first video camera over a second image frame acquired using the second video camera and having a same temporal position coordinate as the first image frame, to use in the video, responsive to determining that the quality metric of the first image frame is better than that of the second image frame. In some embodiments, the video processor may perform hysteresis-based selection of a first image frame over a second image frame having a same temporal position coordinate as the first image frame, to use in the video, by adjusting a threshold or trigger for selecting the first image frame over the second image frame.

In certain embodiments, the video processor may generate the spatial path by at least one of interpolating or extrapolating from the indicated POIs. The video processor may receive, via the user interface, an input from the user specifying a correction to a position of a first POI in the generated spatial path. The video processor may update, responsive to the correction, one or more ROIs for inclusion as scenes in the video.

In some embodiments, the video processor may determine at least a first quality metric for a first POI or a second quality metric for a second POI, for each of the image frames. The video processor may select a first image frame over a second image frame having a same temporal position coordinate as the first image frame, to use in the video, responsive to determining that the at least a first quality metric for a first POI and a second quality metric for a second POI of the first image frame, is better than that of the second image frame.

In another aspect, the present disclosure is directed to a system for improving quality in video production. The system may include a display of a video production device, configured to present to a user image frames for use in producing a video. The video being produced is to have scenes arranged successively at a periodic interval, each of the presented image frames corresponding to a separate scene. A user interface of the video production device may be configured to receive inputs from the user for only a subset of the image frames. Each of the inputs may indicate a point of interest (POI) in a corresponding image frame. The POI may be indicative of a region of interest (ROI) for inclusion as a scene in the video. A video processor of the video production device may be configured to evaluate a spatial path of the indicated POIs relative to a bounding scene of interest (BSI). The BSI may represent a predetermined extent of a field of view of a corresponding camera for image frame acquisition. The video processor may dynamically adjust, in response to the evaluation, the field of view of the camera for image frame acquisition, to steer subsequently acquired image frames and corresponding scenes for the video to be contained within the BSI. The video processor may produce, in accordance with the dynamic adjustment, the video with all scenes arranged successively at the periodic interval.

In certain embodiments, the camera is configured to support spatial pan, spatial tilt and/or optical zoom functions, and the BSI may at least in part be defined by capabilities of the spatial pan, spatial tilt and/or optical zoom functions. In some embodiments, the camera comprises a virtual camera that is configured to use digital pan, tilt and/or zoom functions to identify portions of high definition source images to be extracted as the image frames, and the BSI may correspond to image boundaries of the high definition source images. The video processor may be configured to dynamically adjust the field of view of the camera for image frame acquisition to provide smooth spatial transition of corresponding elements across the scenes of the video. The video processor may be further configured to at least one of interpolate or extrapolate using the POIs of the subset of image frames, to identify ROIs of other image frames for inclusion as scenes in the video.

In some embodiments, the video processor is configured to determine a quality metric for each of the image frames comprising a pixel resolution of a reference POI in each of the corresponding image frames. A first number of the image frames may be acquired using a first video camera and a second number of the image frames may be acquired using a second video camera. The video processor may select a first image frame acquired using the first video camera over a second image frame acquired using the second video camera and having a same temporal position coordinate as the first image frame, to use in the video, responsive to determining that the quality metric of the first image frame is better than that of the second image frame.

In certain embodiments, the video processor is configured to perform hysteresis-based selection of a first image frame over a second image frame having a same temporal position coordinate as the first image frame, to use in the video, by adjusting a threshold or trigger for selecting the first image frame over the second image frame. The video processor may generate the spatial path by at least one of interpolating or extrapolating from the indicated POIs. The video processor may receive, via the user interface, an input from the user specifying a correction to a position of a first POI in the generated spatial path. The video processor may update, responsive to the correction, one or more ROIs for inclusion as scenes in the video.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram of an embodiment of a low-latency interactive visualization system;

FIG. 2a-2c illustrate a delay in video content between that received by a user and that at a data source;

FIGS. 3a-3d illustrate the use of spatial caching under pan-tilt control in one embodiment;

FIGS. 4a-4d illustrate the use of spatial caching under zoom control in one embodiment;

FIGS. 5a-5d illustrate the use of spatial caching to support additional control capabilities in on embodiment;

FIGS. 6a-6c illustrate the use of spatial caching to improve quality of imagery;

FIG. 7 is a block diagram of an embodiment of system for transmitting a reduced representation of video data;

FIG. 8 illustrates a method for determining a minimum required frame rate to keep an object of interest in the field of view of a selected ROI;

FIG. 9A is a block diagram of an embodiment of a system for integrating outputs of a plurality of distributed production components;

FIG. 9B is an example representation that illustrates scalability in integrating outputs of a plurality of distributed production components;

FIGS. 9C-9D are example configurations of streams considered for selection;

FIG. 9E is an example embodiment of a blending algorithm;

FIG. 9F is a block diagram of an embodiment of a system for cascading distribution production components;

FIG. 9G is a block diagram of another embodiment of a system in which results of multiple production modules are fed in parallel to another production module;

FIG. 9H is a block diagram of an embodiment of a system that edits an output of a distributed production module;

FIG. 9I is a block diagram of an embodiment of a system that incorporates or operates with a payments system;

FIG. 9J is a block diagram of an embodiment of a system for video production;

FIG. 9K is a block diagram of an embodiment of a system that implements payment aspects;

FIG. 10A illustrates presence of latency between a local event and a remote production;

FIG. 10B is a block diagram of an embodiment of a system that perform latency and synchronization processing at local and remote locations;

FIG. 10C is a block diagram of an embodiment of a system for managing latency and synchronization over standard IP networks;

FIG. 10D illustrates missing remote-ball-following information due to a momentary delay in a network;

FIG. 11 is a block diagram of an embodiment of a system with asynchronous network connections that produces synchronous output;

FIGS. 12A-12C illustrate separate views of a game;

FIGS. 12D-12E illustrate multiple points of interest in multiple camera views at the same time;

FIG. 12F illustrates part of an embodiment of a method for estimating position(s) of POI(s);

FIG. 12G illustrates the use of calibration and ground plane in determining a position attribute for a POI;

FIGS. 12H and 12I each illustrates a set of sequential frames acquired at different time instants by a respective camera;

FIGS. 12J and 12K illustrate embodiments of a method where an operator clicks on POIs at only certain time instants;

FIG. 12L illustrates an example embodiment of a method for performing interpolation;

FIG. 12M illustrates an example embodiment of a result of interpolation and extrapolation;

FIG. 12N-12O illustrate an example embodiment of aspects of a method for correcting errors in a curve fitting process;

FIG. 12P illustrates an example imagery of player 1 running towards the camera;

FIG. 12Q illustrates an example graph of quality measures of a single POI over time from two video cameras over a time period;

FIG. 12R illustrates an example result of temporal filter or hysteresis processing;

FIG. 12S illustrates an example virtual path that includes regions outside the field of view of a real camera;

FIG. 12T illustrates an example virtual camera trajectory that changes rapidly at two points of time;

FIG. 12U illustrates an example embodiment of a method for computing the y component of a trajectory;

FIG. 12V illustrates an example virtual path with chosen virtual views that are fully contained within the real camera view;

FIG. 12W illustrates an example set of virtual views at different times for a given POI;

FIG. 12X illustrates an example image with a POI moving towards a camera and having a higher quality metric;

FIG. 12Y illustrates an example sequence of images from a produced video; and

FIG. 12Z is a flow diagram of an embodiment of a method for improving quality in video production.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

A video camera can acquire imagery containing many points of interest. Example points of interests may be basketball players, the ball, or a particular person running a marathon. More than one camera may acquire imagery of the points of interest. The multiple cameras may acquire imagery of the same points of interest at the same time from different viewpoints, such as cameras at each end of a basketball game court, or they may acquire imagery of the points of interest at different times, such as cameras positioned along a marathon course. Various embodiments of systems and methods described herein may be used to perform or facilitate production of a video using various sources of acquired imagery.

### Managing Latency of Remote Video Production

In some aspects, this disclosure relates to producing high quality video content in the presence of temporal latency between a remote production station and a local production station, especially in the presence of interactive manual or automatic control of the content. The interactive control may be, for example, control of the portion of the field of view of the imagery being observed by the end user.

In some embodiments, the present system and methods manage the latency using a spatial cache that represents video data with a field of view larger than the portion of the field of video of the imagery being observed by an end user.

In some embodiments the present system and methods also manage the latency using a temporal cache, which in some embodiments is a buffer of images of a particular temporal duration at the local production station. In some embodiments, the length of the buffer delay module is adaptive in response to a measure of latency of the data transmission to the remote production module.

In some embodiments, a reduced representation of the video data content at a data rate that is lower than the data rate being produced by the local production station is transmitted to the remote production station. The reduced data rate representation may be selected in a particular way to minimize the data rate while at the same time maximizing the performance of the remote production module. In some embodiments, the frame rate of the video data content sent to the remote production station is configured to be above a threshold that enables the manual or automatic processing to meet specific required video production quality criteria, in response to events occurring within the video content.

In some aspects, the present system and methods are directed to producing high quality video content in the presence of latency and also interactive manual or automatic control of the content. The interactive control may include, for example, control of the portion of the field of view of the imagery being observed by the end user. The interactive control may be performed by an automatic system, or may be performed by one or more individuals using a joystick or other user interface device. In some embodiments, control of the portion of the field of view of the imagery may be performed using a mechanical method, such as a Pan/Tilt/Zoom mechanism that is known in the art to point a camera in different locations, or an electronic method where a dynamically-selectable region of the imagery is cut-out or selected from a larger region of imagery acquired from a fixed camera, or a combination of both as is described herein. In some embodiments, the imagery being used to control the camera (either manually or using automatic means) may not be the same imagery being observed by the end user.

One aspect of interactive spatial experience may include the response time to a user command to execute a pan, tilt or zoom. This response time is also known as latency. There are several factors that contribute to latency that can include transmission delays, transmission latency due to intermediate buffers (e.g., transmission buffers, processing buffers), command processing delay, and/or view rendering on a display. In some embodiments, the largest contributors to latency are transmission delays and transmission latency due to intermediate buffers. Latency between the automatic or manual control of the viewing region of interest, and the process that selects or cuts-out the region of interest can result in a region of interest that is different to the region of interest the control method select. In cases where the desired region of interest is moving, for example as in a sports event, then this can result in the region of interest missing or following behind the actual action. Manual or automatic control can also result in unnatural camera motion that is too fast, slow or jerky, for instance. In the case of the electronic selection of the imagery, it is possible to request imagery that is outside the imagery available. In addition, the latency involved may change over time and be unpredictable.

In some embodiments, the present system and methods introduce the concept of “spatial caching” and teaches methods to support local execution of control commands to significantly reduce latency by eliminating two prominent latency contributors: transmission delays and transmission latency due to intermediate buffers.

In some embodiments, the present disclosure further provide methods to provide additional advanced view modification controls with reduced latency even if the data source does not support those controls.

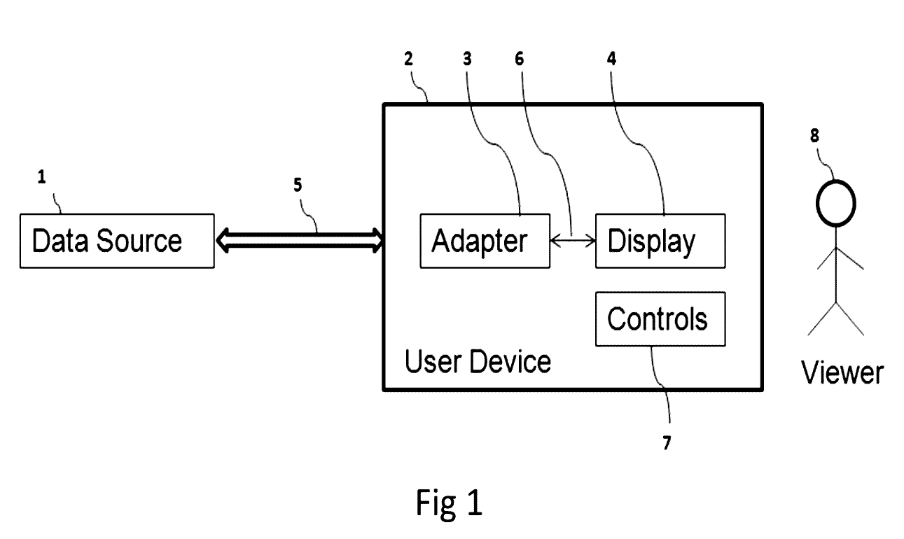

In some embodiments, the present disclosure further provides method to provide stabilized synthesized views with significantly reduced latency even if the data source is jittery and unstable. FIG. 1 shows a block diagram illustrating in some embodiments key components of a low-latency interactive visualization system. The data source 1 may represent live or recorded multimedia source that supports at least basic spatial interactivity such as selection of regions of interest by at least one remote user device 2. The user device 2 can include an Adapter 3, Display 4 and Controls 5. The adapter 3 can provide means to receive the data in the source format, and convert into a format suitable for the Display 4. The adapter in addition to format conversion may also include a ROI (Region of Interest) determination logic to request ROI from the data source as necessary, and image processing means for functions such as format conversion, image alignment, warping. The Display 4 can provide means to show multimedia data to a Viewer 8 (e.g., a user or operator) observing the Display 4. The Viewer 8 interacts with the Display 4 using a Control module 7. The Control module may support one or more of input devices such as keyboard, mouse, joystick, and touch screen. It may provide controls for pan, tilt, zoom, and more advanced features such as drag, roll, and perspective change.

In some embodiments, the User Device 2 may interact with the Data Source 1 via a communication interface 5. This interface is a bi-directional interface supporting multimedia content transfer from Data Source 1 to the User Device 2, and ROI control messages from the User Device 2 to the Data Source 1. The communication interface is a typical source of latency.

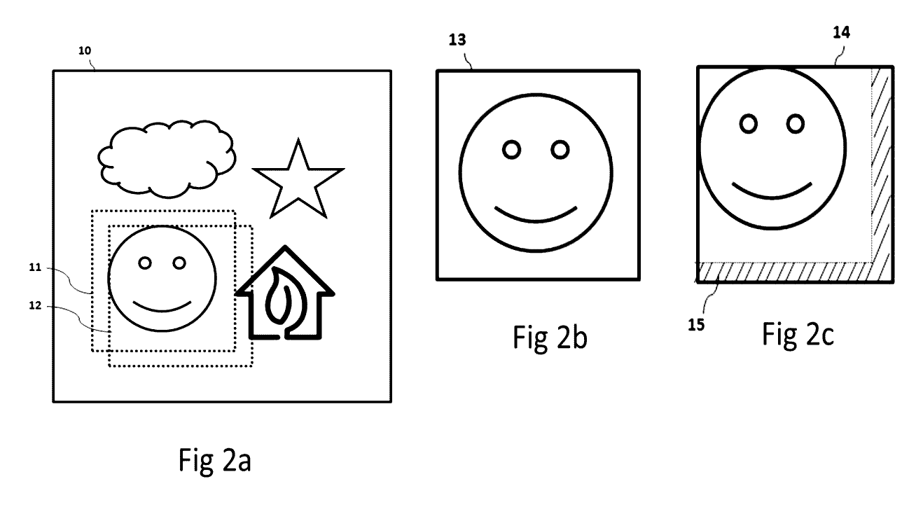

FIG. 2a shows an exemplary steady-state snapshot 10 at time T₁ of a video source, and a region of interest (ROI) 11 that data source is serving to a user device. A snapshot of video 13 received by the user device and displayed to its viewer is also shown in FIG. 2b. Note, the video content of ROI 13 received by user at time T₁ may in general be delayed compared to video content of the same ROI 11 at the data source.

A viewer using pan-tilt control at a future time T₂ may request ROI 12. However, due to latency, the user device may continue to receive video corresponding to ROI 11 for additional duration equal to latency. The user display during this latency period may continue to display the video from ROI 11 as it is received. This may have a disadvantage that the viewer gets an impression of slow response of their control, resulting in the ROI lagging behind the desired position. In alternate implementations of user-interaction, the device can spatially warp (spatially geometrically transforms) the received video corresponding to the pan-tilt control command before displaying it to the viewer. This can address the impression of slow response, however, but can have a disadvantage that certain blank/missing areas 15 may appear in the view during the latency period in some embodiments. At the end of the latency period, video corresponding to the requested ROI may arrive and the display area may be fully rendered without any blank/missing areas. Alternate implementations may smoothly transition the incoming video from an outdated ROI 11 towards the requested ROI 12 while waiting for the updated view. In this approach, the blank area is only gradually exposed. This may perceptually reduce the visual impact of blank areas in the display, but the effect may continue to exist.

For illustration purposes only, the various ROIs are shown to be rectangular in shape. In general, the ROIs may correspond to arbitrarily-shaped masks. Further, the ROIs may be generated through computational means, based on request parameters such as camera calibration parameters, pan, tilt and/or zoom.

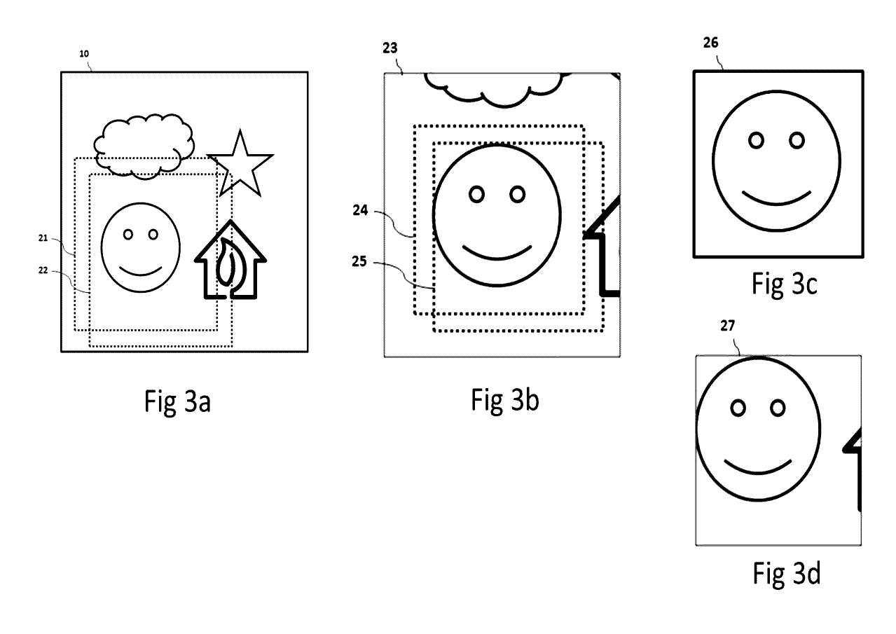

FIG. 3 illustrates in some embodiments “spatial caching” under pan-tilt control, in accordance with embodiments of the present systems and methods. FIG. 3a shows in some embodiments an exemplary steady-state snapshot 10 at time T₁ of a video source, with a region of interest (ROI) 21 being served to a user device. A snapshot 23 of video as received by the user device is also shown in FIG. 3b. However, the user device displays only a smaller ROI 24 of the snapshot 23 to the viewer. A snapshot 26 of the video corresponding to ROI 24 is shown in FIG. 3c. The remaining portion (e.g., video data outside of ROI 24) is maintained as spatial cache. In other words, although the viewer wants video corresponding to only ROI 24, the underlying user device may instead request a larger ROI 21 from the data source.

In some embodiments, a viewer using pan-tilt control at a future time T₂ may request ROI 25 of FIG. 3b. Since video corresponding to ROI 25 is already being received by the user-device, the user-device may now instantly configure the display area to the desired ROI 25. A snapshot of the updated view 27 is illustrated in FIG. 3d. Simultaneously, the user device may initiate a request for a new ROI 22 from the data source in anticipation of additional pan-tilt requests from the viewer. In some embodiments, the use of spatial caching eliminates the need to wait for video corresponding to the requested ROI 25 in order to respond to a viewer's pan-tilt control requests. In some embodiments, the availability of the spatial cache can ensure all transmission-related latencies are eliminated from the viewer's perspective and the display responds immediately to viewer requests. Further, no blank/missing areas are introduced in the display. In alternate embodiments, the user-device may smoothly transition the ROI from 24 to 25 to provide a more visually pleasing transition for the viewer.

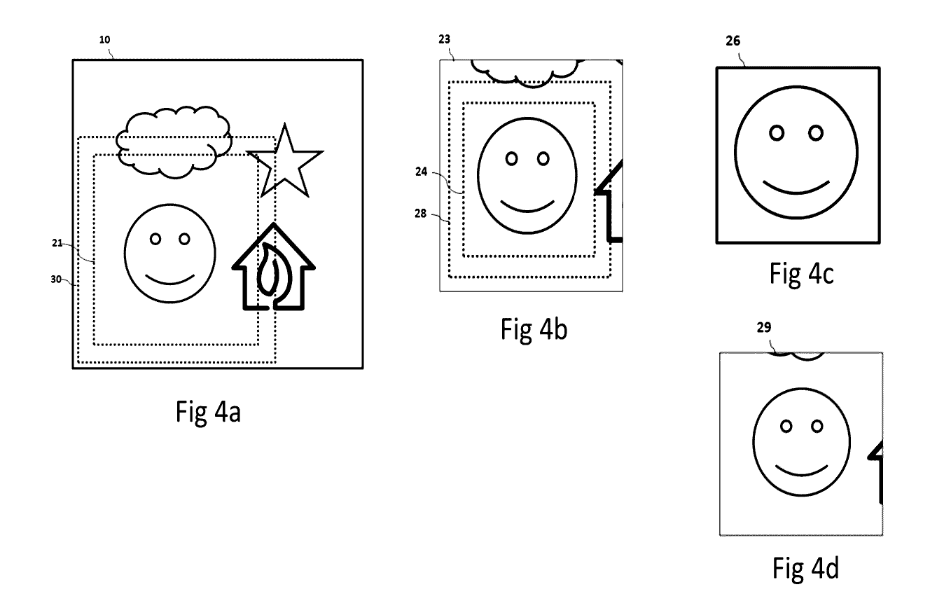

FIG. 4 illustrates “spatial caching” under zoom control, in accordance with some embodiments of the present systems and methods. FIG. 4a shows an exemplary steady-state snapshot 10 at time T₁ of a video source, with ROI 21 being served to a user device. A snapshot 23 of video as received by the user device in some embodiments is illustrated in FIG. 4b. However, the user device may display only a smaller ROI 24 of the video 23 to the viewer. A snapshot 26 of the video corresponding to ROI 24 is illustrated in FIG. 4c. The remaining portion (video data outside of ROI 24) may be maintained as spatial cache. In other words, although the viewer needs video corresponding to only ROI 24, the user device instead may request a larger ROI 21 from the data source.

In some embodiments, a viewer using zoom control at a future time T₂ may request ROI 28 of FIG. 4b. Since video corresponding to ROI 28 is already being received by the user-device, the user-device may instantly configure the display area to the desired ROI 28. Note, the display resolution may be the same but the desired ROI 28 is larger, therefore, the video from ROI 28 may need to be resized to fit the display. A snapshot 29 of the updated view is illustrated in FIG. 4d. Simultaneously, the user device may initiate a request for a new ROI 30 from the data source in anticipation of additional zoom and/or pan-tilt requests from the viewer. The use of spatial cache can eliminate a need to wait for video corresponding to the requested ROI 28 in order to respond to viewer's zoom control requests. In an alternate embodiment, the user-device may smoothly transition from ROI 24 to ROI 29 to provide a more visually pleasing transition for the viewer.

The availability of “spatial cache” has an added advantage in some embodiments that the user-device does not have to communicate every ROI adjustment request to the data-source. The user-device may need to request only coarse-level adjustments whenever the spatial cache is anticipated to run out. All fine-level adjustments to ROI adjustment request may be handled locally by the user-device using the spatial cache. ROI adjustment requests may require extra processing or dynamic re-configuration at the data source, which may temporarily interrupt data flow, lead to data loss, and/or lead to other data-source-specific performance loss. In some embodiments, by reducing the number of ROI adjustment requests, the performance of data source may improve.

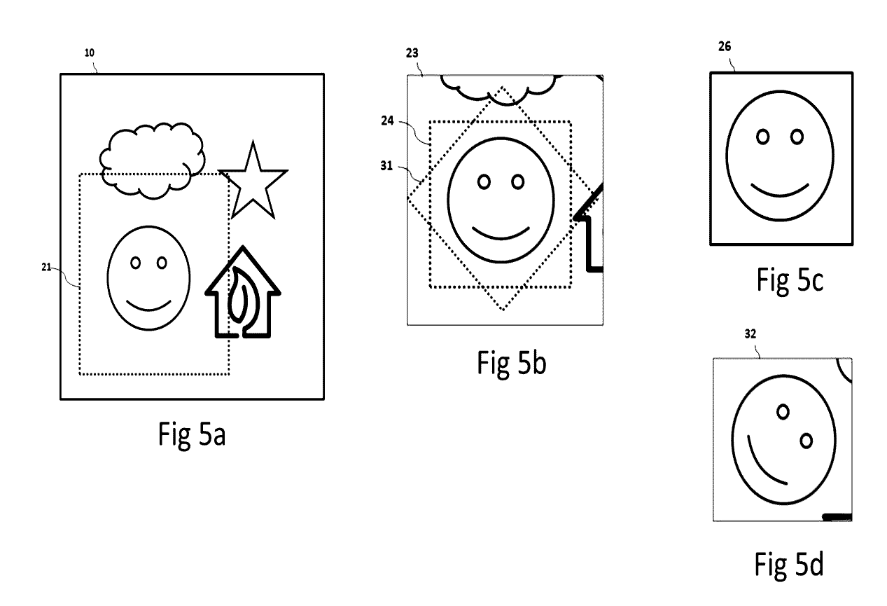

FIG. 5, illustrates in one particular embodiment the use of “spatial cache” to support additional control capabilities not integrally supported by the data source, in accordance with embodiments of the present methods and systems. For instance, a data source may support only rectangular ROI selection and only a few discrete zoom levels. It may also be the case that only a finite set of rectangular ROI selections are supported such as set of ROIs with only integer coordinates. The availability of spatial cache can overcome the limitations of the data source to support advanced viewing controls such a smooth view transitions that require sub-pixel shifts, roll of view, and other general geometric transformations.

For illustration purposes only, the data source used in the embodiment shown in FIG. 5 may only support rectangular ROIs and does not support an advanced control such as image “Roll”. FIG. 5a shows an exemplary steady-state snapshot 10 at time T₁ of a video source, and is serving video from ROI 21 to a user device. A snapshot 23 from the video as received by the user device is also shown in FIG. 5b. However, the user device displays only a smaller ROI 24 of the snapshot 23 to the viewer. ROI 31 is requested by a viewer at time T₂ using an image Roll control. The user-device can employ image-processing means to warp the imagery from requested ROI 31 already being received by it to generate the view 32. The “spatial cache” was again leveraged to create a rotated image without any blank/missing portions. Further, the user-device device may have employed a sequence of progressive warps to smoothly rotate the image to the desired ROI. These extra capabilities may be achieved in spite of limitation of rectangular ROIs of the data source.

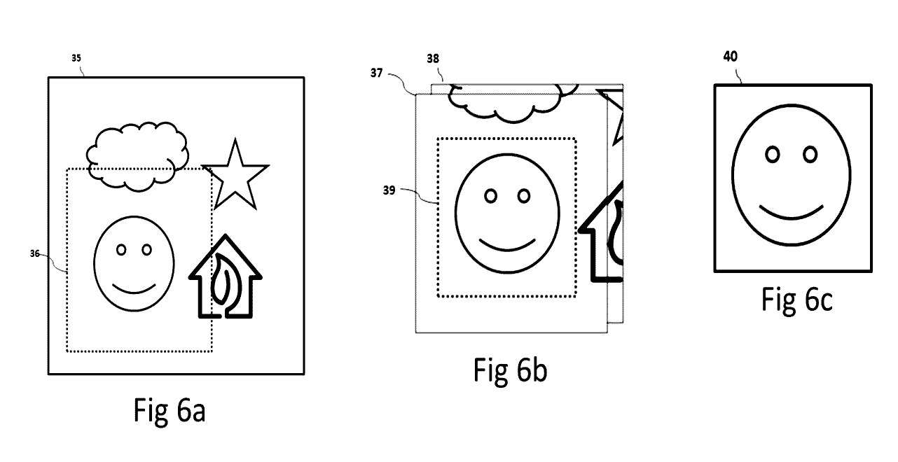

FIG. 6 illustrates use of “spatial cache” in another particular embodiment to improve the quality of imagery received from a data source, in accordance with embodiments of the present systems and methods. For instance, a data source may be generating shaky video. FIG. 6a shows an exemplary steady-state snapshot 35 at time T₁ of a video source, with video from ROI 36 being served to a user device. Two frames (e.g., snapshots 37 and 38 separated in time) of the video as received by the user device are also shown in FIG. 6b. The two frames may be displaced from each other because the data source is shaky. As an example, frame 37 is treated as the reference frame. The user-device may employ image-processing means to align frame 38 to reference frame 37. After aligning frame 38, it may extract the ROI 39 from aligned frame 38 to generate resulting view 40. The view 40 over time shall appear stabilized, even though the original data source is shaky. Further, the stabilized view would not have blank/missing parts provided the extent of spatial cache exceeds the amount of shakiness. The availability of spatial cache can overcome the limitations in image quality of the data source to provide an enhanced viewing experience.

As mentioned previously, in some embodiments, it may be desirable to keep the ROI selected for viewing to be contained within the active region of the field of view of the sensor, so that no border effects such as dark or black pixels need to be displayed or otherwise addressed. In some embodiments, this can be done by clipping or limiting the pixel coordinate positions that define the selected ROI so that it is impossible for the ROI to be positioned outside the sensor field of view. However, such clipping or limiting can result in abrupt motion of the ROI over time. For example, the ROI may be moving rapidly towards the edge of the sensor field of view. It has previously been described how filtering of the desired position can prevent abrupt changes in the position of the ROI, but in certain embodiments a major problem is that in order to achieve this then data for the desired ROI input is required not only from the current time instant but also from future time instants. In one embodiment of the present systems and methods, this problem is overcome by temporal buffering of the image data as well as the desired ROI input data, by smoothing the desired ROI inputs as previously described, and by applying the filtered output response to the time-delayed video. The temporal buffering of the data can be achieved by a set of memory buffers each the size of the data set (for example the size of an image), and as new image data is acquired then the last buffer holding data may get overwritten, and then the process repeats such that each buffer may be cycled through over a time period. The number of buffers can control the amount of temporal delay introduced since the image data arrives at a constant frame rate, and data from all buffers excepting the buffer being written into at any moment in time can be accessed for processing or display.

In another embodiment, the length of the delay is reduced by determining when the ROI selected either by the user or as a result of the smoothing processing is predicted to be outside the field of view of the camera. The required length of the delay may be reduced by the following: If it is thought that the smoothness of the position of the selected ROI needs to have a smoothness constant of 2 seconds (which in this context means that the speed of the moving ROI would change from the highest allowed speed to stationary smoothly in 2 seconds), then this means that without prediction the required delay would need to be at least 2 seconds in length. In the case of buffers with a shorter delay, for example 0.5 second, then similar processing can be used to smooth the ROI position but in addition a prediction of the expected ROI position without any further consideration can be computed based on the velocity and acceleration of the virtual position of the ROI. These values can easily be computed by taking the differences between either the desired input ROI positions or the processed output ROI positions. Returning to the example, then with a 0.5 second actual buffer delay the ROI position can be computed 1.5 seconds in advance of the buffer, resulting in a real and predicted time delay of 2 seconds. If the predicted position is within a threshold distance of the edge of the camera field of view then the speed of the virtual camera (that defines the ROI positions) can be slowed immediately and smoothly by reducing the computed ROI motion by a factor.

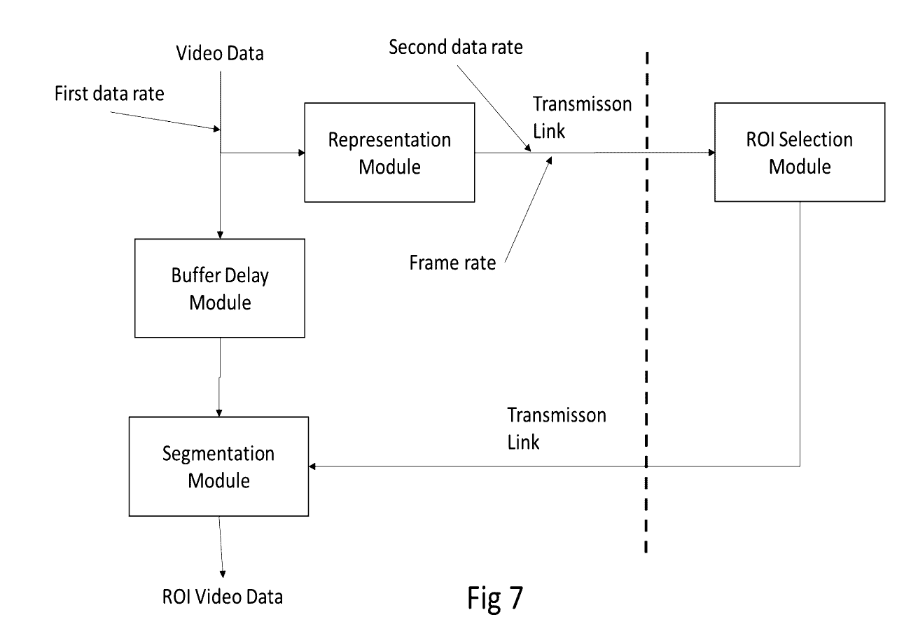

In a related embodiment, a system for producing high quality video is as follows. Video data from a sensor at a first data rate may be passed through one or more buffers that introduce a time delay as described previously. A reduced representation of the video data at a second data rate that is lower than the first data rate is transmitted to the ROI selection module that may be remotely located, as shown in FIG. 7. In some embodiments the advantage of this approach is that there is less data to transmit to a remote location, which allows cheaper network infrastructure to be used to the remote location. For example, if the first data rate is a color video stream with 4K pixels at 60 frames per second, then even a compressed bit rate may be approximately 50 MBps. Expensive, high-bandwidth network infrastructure, such as Gigabit Ethernet, can be used relatively inexpensively between the video source, the video buffer delay module, and the segmentation module because in some embodiments they can be geographically located close to each other. In some embodiments however, the ROI selection module is desired to be at any remote location which may have network infrastructure, such as DSL, that can only support much lower bandwidth network. DSL has a typical maximum bandwidth of 3 Mbps, for example. Crucially, it is the lowest-bandwidth link in the chain of communication between the local production station and the remote production station that limits the bandwidth to the remote production station, and so as the remote production station is positioned further geographically from the local production station, then in general the more likely the network bandwidth would be limited due to the additional communication links in the data path.

The reduced data rate representation may be selected in a particular way to minimize the data rate while at the same time maximizing the performance of the ROI selection module. More specifically, the performance of the ROI selection module would have that the frame rate of the data exceed a threshold that enables the manual or automatic processing to meet a specific required response time of the virtual camera, in response to the events occurring within the content. In some embodiments, an element that controls the frame rate threshold is the application of videography best practices in selecting the ROI in response to the scene content. In some embodiments a primary requirement of videography best practices is that that activity remains within the ROI and therefore visible to an observer. A minimum frame rate therefore needs to be selected to ensure that even with expected change in positions of points of interest over time in response to events in the scene, then the best-practice rule is met. In one example embodiment, a single camera may have a lens with a field of view such that the entire length of a playing field just occupies the entire horizontal field of view of the camera.

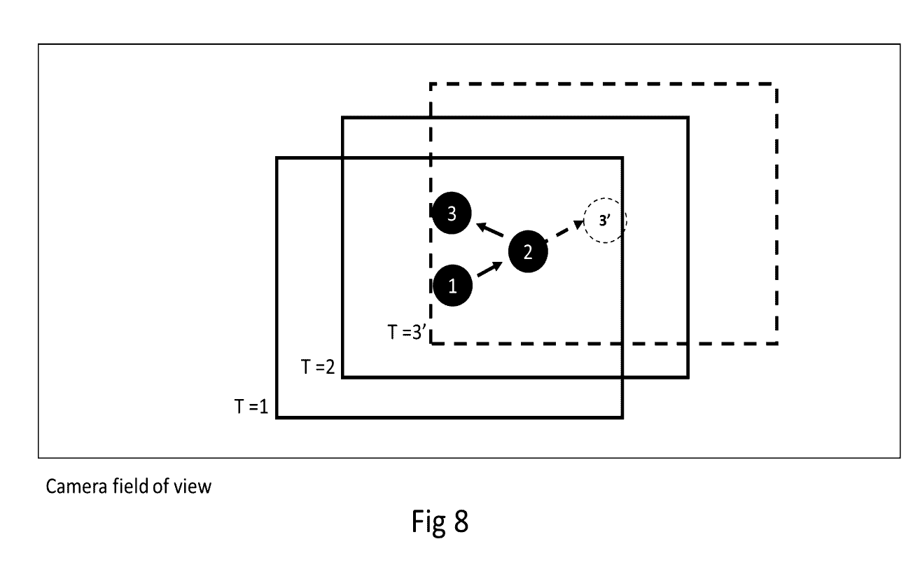

FIG. 8 shows in one embodiment a method for determining the minimum required frame rate to keep an object of interest (a ball) in the field of view of the selected ROI. The large rectangle indicates the field of view of the actual camera. The smaller rectangle T=1 shows the virtual field of view chosen by the segmentation module in FIG. 8. As the ball moves across the scene, if the frame rate of the ROI selection process is lower than the frame rate of the output video (see FIG. 7), then the segmentation module in FIG. 7 predicts the position of the ROI in frames where ROI selection data is not available. One means for predicting the position of the ROI is based on the velocity of the ROI from the previous 2 ROI selection time instants. This is shown in FIG. 8, whereby the dotted rectangle marked T=3′ shows the ROI predicted from T=1 and T=2 by linear extrapolation of the position of the ROIs at times T=1 and T=2. In this case however the actual ball position at T=3 is different from the prediction, as shown in FIG. 8, but still the predicted ROI is used for display. As discussed, in some embodiments it is preferred to keep the actual ball in the field of view of the predicted ROI. This may be accomplished by ensuring that the frame rate is above a threshold so that an incorrect prediction of the ROI still includes the object of interest that is moving at a maximum expected speed for that particular object of interest. FIG. 8 shows the critical sampling of the frame rate whereby the actual ball “3” is just at the edge of the predicted ROI at time T=3′.

In some embodiments, if the maximum speed of activity to be included in the ROI is S fields-of-view per second, and the horizontal width of the ROI is a factor N of the entire field of view of the camera (where N<1), then the number of frames per second required to keep the activity in the field of view may in some embodiments be S/N. The formulation shows that as the speed of the object of interest in the scene increases, then the required frame rate also increases. The formulation also shows that as the ROI size and therefore N get smaller, than the required frame rate also increases since the object of interest leaves the field of view of the ROI faster.

In some embodiments, measurements from videos of basketball games indicate that the maximum speed S of a basketball (e.g., the maximum speed occurs when the ball is thrown) is approximately 0.5 horizontal field-of-views per second measured with respect to the actual camera field of view (the large rectangle in FIG. 8. In some embodiments the horizontal pixel width of a camera is 4096 pixels, and the horizontal width of a ROI with a resolution of 1080P (High Definition) is 1920 pixels. In this embodiment, therefore, N is 1920/4096. The minimum frame rate is therefore 0.5/(1920/4096)=1.066 frames per second, for example.

Examples of methods for implementing reduced representations of the video that reduce the data rate include compression of the video, and subsampling of the video either spatially or temporally. Examples of transmission methods include TCP/IP, the protocol for the transmission of data over the internet. The ROI selection module can process the reduced representation of the video as previously described to define ROI positions as described. These ROI positions are then transmitted to a segmentation module connected to the buffers of the video data, as shown in FIG. 7. The segmentation module can operate on video data from the sensor at the first data rate. An example of an implementation of the segmentation module is to crop from the video data the pixel area defined by the ROI, as shown in FIG. 8.

In one embodiment, the ROI selection module may be implemented by a GUI whereby a viewer observes the video and the desired position may be chosen manually with repetitive mouse clicks, or by an automatic ball-following algorithm. An example of a ball-following algorithm is the detection of circular objects in the video using a Hough Transform configured for circle detection (U.S. Pat. No. 3,069,654).

In some embodiments, the length of the buffer delay module in FIG. 7 is adaptive in response to a measure of latency of the data transmission bandwidth to and from the remote ROI selection module. In some embodiments, the length of the buffer delay is configured to be at least the length of the measured transmission latency, for example, if the latency is L seconds, then the length of the buffer delay module is configured to be at least L seconds. This ensures that commands issued by the ROI selection module would still be able to operate on video data captured L seconds previously. In some embodiments, one method of measuring the latency is to use the Unix Ping utility, known in the art, and to measure the time for test data packets to travel from one location to another. In some embodiments, the packet delay is measured and then the latency L and the buffer length is configured to be this value.

In some other embodiments, the length of the buffer delay module in FIG. 7 is also adaptive in response to a measure of variation of the data transmission bandwidth to the remote ROI selection module. The human visual system is very sensitive to even small artifacts in video, such as a missing frame or a momentarily delayed frame. Ensuring that the buffer is just long enough to accommodate the average latency would mean that any momentary instances of longer latency can result in artifacts or poorly produced video since the ROI selection data would arrive too late for image data to still remain in the buffer. In some embodiments this is addressed by first defining a quality metric for allowable artifacts. In some embodiments, this quality measure is the time period Ta in which no artifacts due to incorrect configuration of the buffer length L are to be allowed. In some embodiments the time taken for data to be transmitted to and from the remote location over the period Ta is measured. This is repeated to produce a series of values of measured latency each over time period Ta. In some embodiments, the buffer length L is set to a non-linear function of these values so that the buffer length is responsive to the longest delays and not the average delays. In some embodiments, the non-linear function is the maximum function of the time series values of Ta.

### Distributed Broadcast Production

In some aspects, this disclosure relates to producing high quality broadcast video content where the production components are distributed across different people and/or geographically.

In one embodiment, the present methods and systems can integrate outputs of a plurality of distributed production components in order to maintain broadcast production quality if one or more production components fails to deliver production material of sufficient quality.

In another embodiment, the present methods and systems can integrate outputs of a plurality of distributed production components such that transitions between use or dis-use of production components produces a seamless produced video output.

In another embodiment, the present methods and systems can cascade distribution production components such that the output of one distributed production component is the input of a second distributed production component still maintaining at the output of the second production component an assessment of production quality that is a function of the first distributed component and the second distributed component.

In another embodiment, the present methods and systems can produce high quality video content where the production components are distributed across different people and/or geographically, and where a first production component is being performed at a video frame rate that is greater than the frame rate of one or more production components, subsequent to an editing step being performed by the first production component.

In another embodiment, the present methods and systems can incorporate or operate with a payments system that automatically reimburses service-providers of distributed production components based on the quality of the produced content from the service-provider's production component.

In some embodiments, the present methods and systems can produce high quality video content where the production components are distributed across different people and/or geographically. The distributed production components may be operated by distributed service providers where management and quality control of the service is uncertain. For example, video production can be performed by skilled professionals managed in a highly-controlled and centralized fashion as a means to ensure quality of video content production. However this can be an expensive means of ensuring quality of production since the labor cost of skilled professionals is high. It is also not a scalable means of ensuring quality of production over very large numbers (e.g., millions) of video feeds distributed widely geographically, at least because large numbers of skilled professionals do not exist, and also because tight management control and quality control of widely distributed operations performed even by skilled professionals is difficult and expensive.

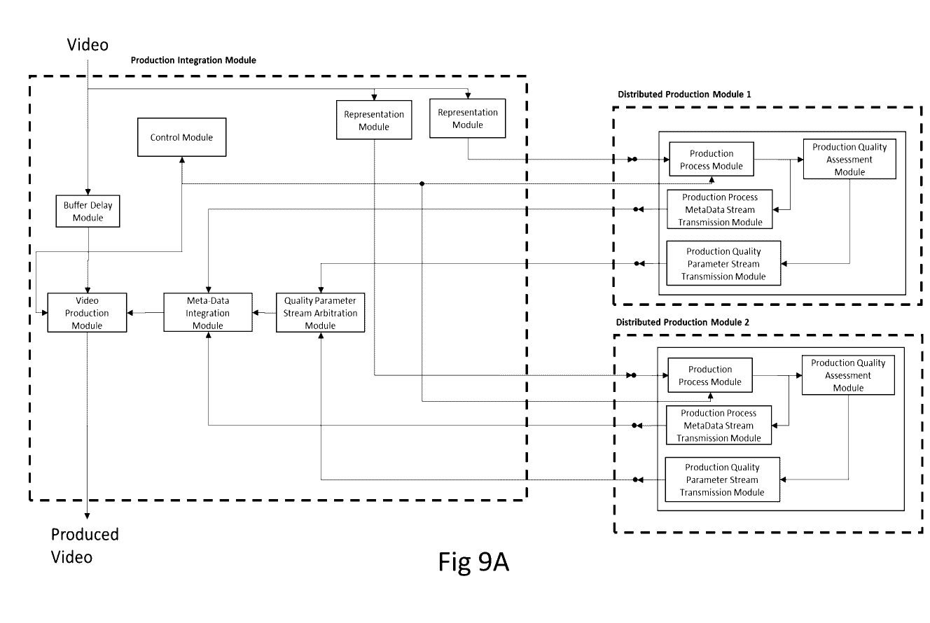

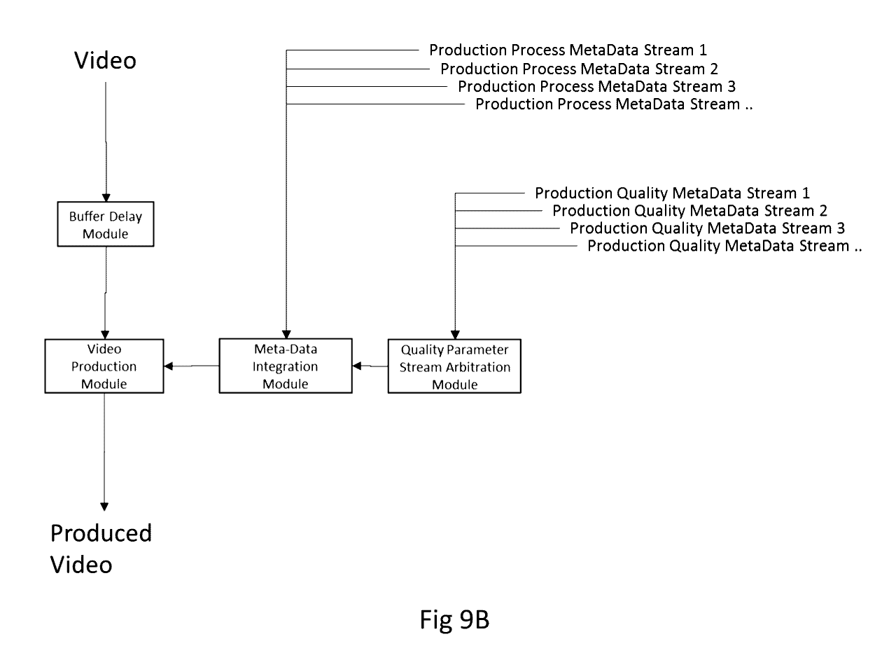

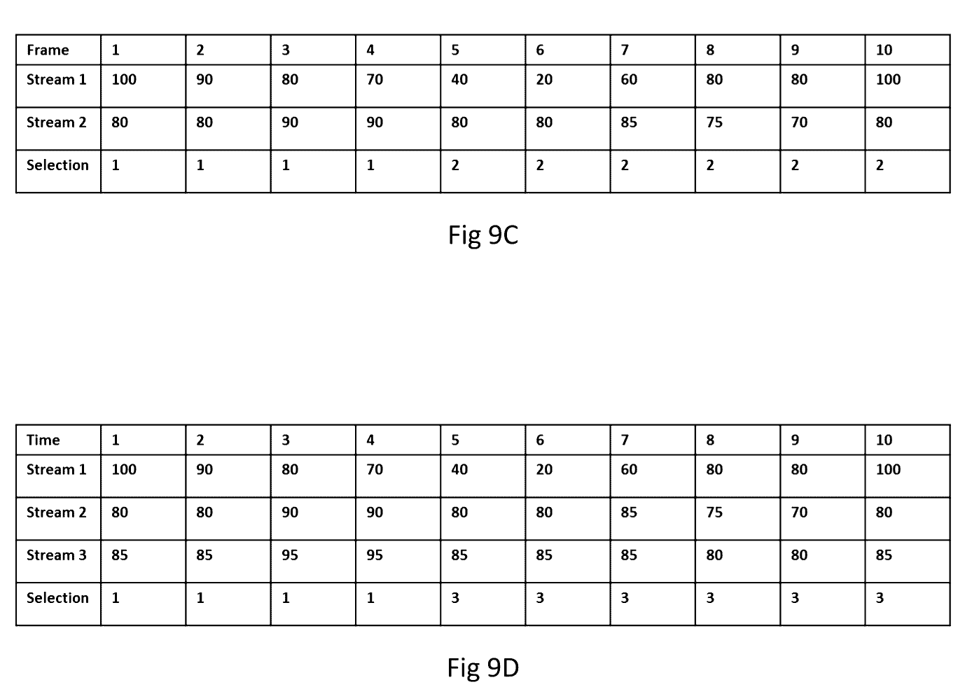

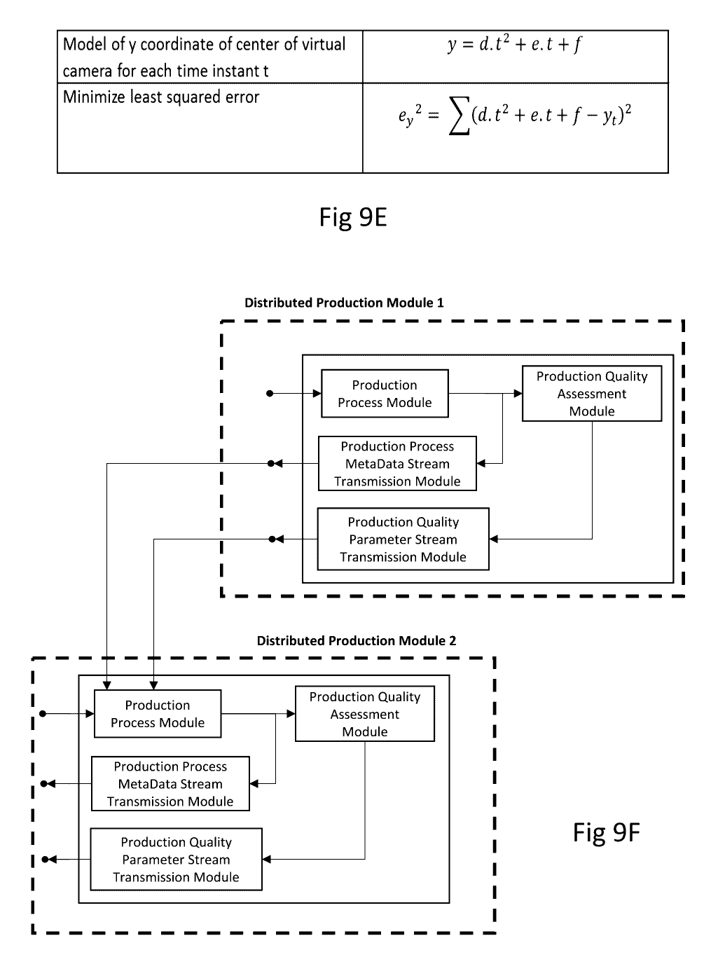

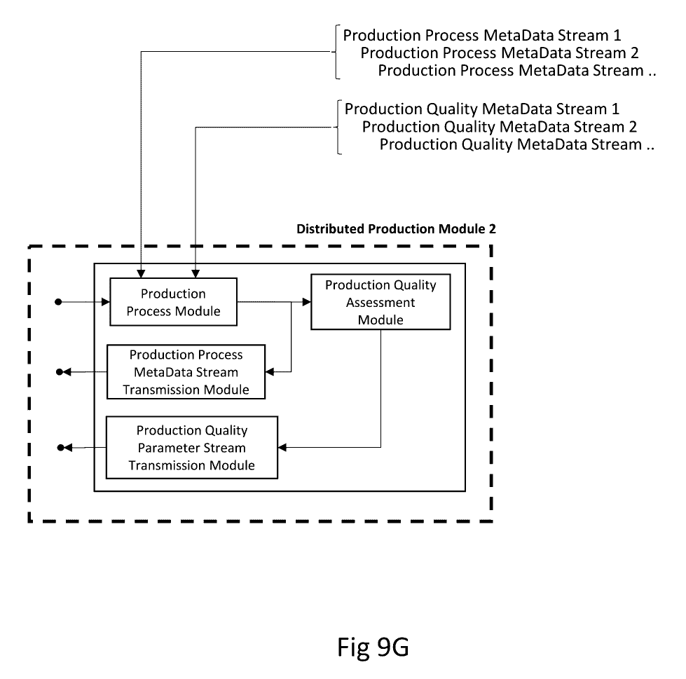

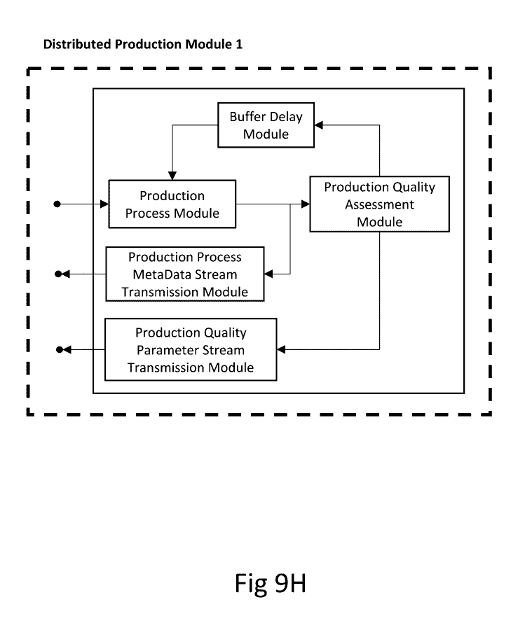

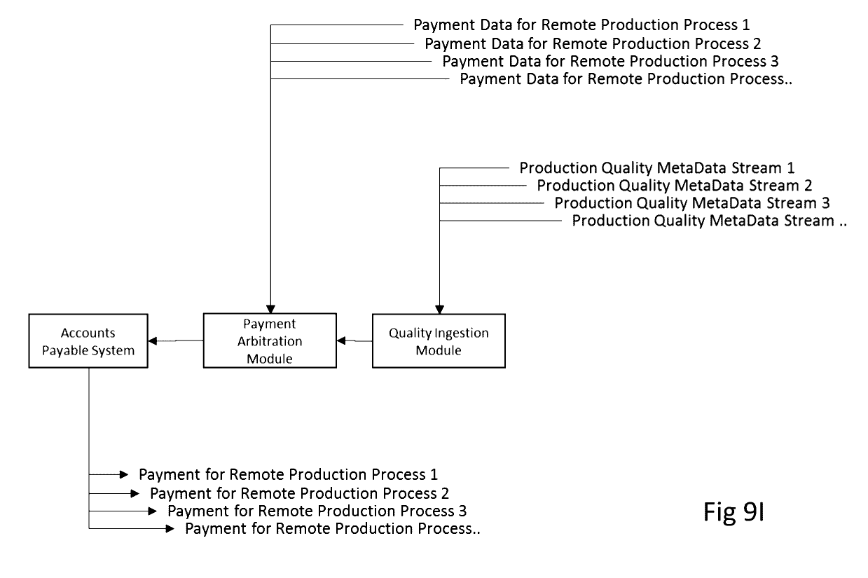

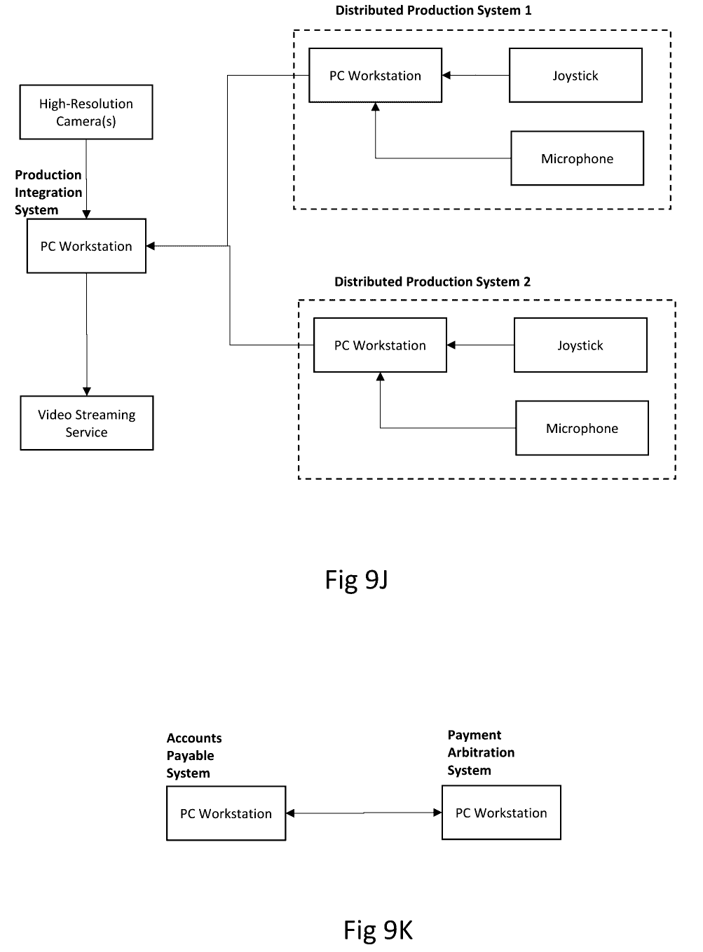

In one embodiment, the present methods and systems can integrate the outputs of a plurality of distributed production components in order to maintain production quality if one or more production components fails to deliver production material of sufficient quality. FIG. 9A shows an example of an embodiment of a system for integrating outputs of a plurality of distributed production components. The figure shows three modules, each of which may be widely separated geographically, and each of which may be operated and managed by different service providers with little or no management oversight for example. The first and second modules to the right of FIG. 9A may be referred to as distributed production modules. Each of these modules may be performing a different production process. For example, the first module may be designated to automatically or manually follow the activity in a sports event in the field of view of a camera so that parameters related to the location of the activity are recovered. The second module, for example, may be designated to automatically or manually determine graphic elements related to ongoing events in the sports (such as a digital scoreboard overlay, or real-time Twitter® feeds from commentators). The third module to the left of FIG. 9A may be referred to as the production integration module. This module can ingest source video data, control which Distributed Module performs which element of the production process, and/or integrate results of the distributed production processes to generate the final produced video stream.

In one embodiment, a first step in the process may begin with the control module within the production integration, as shown in FIG. 9A. The control module may comprise a software module (executing on hardware of the system) that contains a database with two primary elements for example. A first element may include a list of events that are to be produced together with the production elements (e.g., activity following, graphic overlays, audio commentary, etc.) that a production supervisor or other personnel has designated as being necessary or desired for a particular event. A second element may include a list of distribution production modules and their capability to provide one or more associated production elements during the time period in which the event is scheduled to be produced. For each event on the list, the software module may retrieve data corresponding to the required capabilities at the required times from the database, and then perform a search through the database for a complete set of distributed production modules that can provide the elements of a complete production. Each distributed production module may be identified by a unique identifier code, such as a unique IP (Internet Protocol) address.

Another step in the process in the embodiment may begin shortly before the event is due to be produced. The control module can compare the current time to the scheduled time of an event in the database, and if the difference in these times is less than a threshold (a preferred time difference is 30 minutes or less) then the control module cam send a signal to the distributed production module using the unique identifier (such as a unique IP address) as a means to direct the signal. In some embodiments, the signal is transmitted to a production process module, which is a sub-module of the distributed production module shown in FIG. 9A. The signal may request confirmation of availability of the required resources for its designated production process. For example, in the production process module, several verifications may be performed: the identity of the operator of the distributed module may be confirmed using a username and password, in order to confirm that the operator has the required experience to perform the required production element. In another example, all software modules and hardware modules (such as a joystick) involved in the production element may be interrogated to ensure that they are operating within specification. Results of the verifications may be sent back to the control module. Standard TCP/IP communication protocols may be used for the communication. This process may be repeated for all other distributed production modules. If any distributed production module did not respond to the original signal within a prescribed period of time (e.g., a preferred time is less than 5 minutes), or if the results of the data verification indicate that the required resources are not in fact available at the location of the planned distributed production module (e.g., the designated human operator was sick) then the control module may automatically re-access the database to identify a potential replacement distributed production module, following the same/similar steps by which the original set of distributed production modules were identified.

A next step in the process flow in the embodiment may correspond to the actual production process. A first component in this step may include transmittance of a representation of the video, typically at a lower resolution than the original video, to the production process module. U.S. Provisional Patent application 62/250,186 describes particular methods by which the Representation Module performs this component. The production process module can perform the production element, such as activity following. For example, an operator may use a joystick to move a cursor to the center of activity in a sports event, so that as a ball moves from one side of a stadium to the other, then the coordinates of the activity is followed. Methods for performing this are also described in U.S. Provisional Patent application 62/250,186. In some embodiments, an important element of the distributed production module is the production quality assessment sub-module shown in FIG. 9A. In this module, the quality of the production may be continually assessed in real-time. In some embodiments, one example of an assessment of quality is a determination of whether the operator is still physically at the production module. For example, a software module may detect that a keyboard button is pressed every 10 seconds or less. Absence of such a keyboard press can be detected and can be used to change the quality assessment. In such cases, the operator may have walked away from the keyboard temporarily so that the assessment of quality is reduced greatly.

Results of the production quality assessment module and the production process module itself are then transmitted back to the production integration module by means of the production process metadata stream transmission module, and the production quality parameter stream transmission module, also shown in FIG. 9A. These modules can assign a unique video frame number to the metadata and quality assessment results, in order to synchronize the results of the two processes with the video data. This synchronization can be used in an integration process that is to be discussed later. Note that in some embodiments, the actual video data does not have to be re-transmitted back to the production integration module and only the metadata and quality assessment data is transmitted. In some embodiments, the input to the production process module (e.g., joystick positions before any post-processing such as filtering or smoothing) are also included in the metadata since this can facilitate efficient integration of the metadata between multiple distributed production modules, as described later.

In some embodiments, a meta-data integration sub-module within the production integration module may ingest the production process metadata streams from a plurality of distributed production process modules, while a quality parameter stream arbitration module ingests the quality assessment streams from the same plurality of distributed production process modules, as shown in FIG. 9A. FIG. 9B includes an example representation that illustrates scalability of the approach and how production metadata and quality data may be ingested from any number of distributed production modules.

A next step in the process flow may include processing the quality parameter streams. In the meta-data, each video frame associated to each process may have a frame number, and at least one quality metric assigned to it (as shown in rows 2 and 3 of FIG. 9C as an example configuration). In one example of an embodiment, the control module that originally designated distributed production modules may have designated multiple modules that perform the same production process to provide redundant production capability in case one process fails in the middle of a live production. In another example, a master distributed production module may be available at very short notice but unused, until the quality parameter arbitration module determines (as shall be described) determines that the master distributed production module should be involved. In one embodiment, the quality parameter stream arbitration module begins by taking the highest numerical quality from two distribution processes. Then for each frame, the quality parameter arbitration module may compare each quality value in the selected quality stream to a nominal quality standard value. In this embodiment, if the quality parameter drops below this nominal quality standard value, then the arbitration module may search for a second quality stream that has the required metadata above the nominal quality standard value, and may select the second quality stream. This is illustrated in FIG. 9C where quality stream 1 is initially selected as shown in row 4, but when the quality drops below the nominal quality value of 50 at frame 5, then the selection process switches to stream 2 that has a quality factor of 80 that is above the nominal quality value threshold.

In some embodiments, the selection may be subject to hysteresis that requires that the selection remains constant for at least a time period (e.g., a preferred value may be 1 minute or less) or at least a particular number of frames (e.g., a preferred value may be 3000 frames or less) regardless of the quality values. This is because a subsequent process—by the metadata integration module—may use data from multiple frames over time to blend or merge the metadata from different production processes (e.g., even of the same type) so that switching the selection between production modules operated by personnel with different performance characteristics does not result in a step response in the produced video output, as shall be described later.

In another embodiment of the arbitration module, selection may be based on a filtered output of some or all of the quality streams. In some embodiments, the filtering may be an outlier rejection method such that, for example, if any of the streams is different from the average of the other streams by more than a threshold, then it is not considered for selection. An example embodiment or configuration of this is shown in FIG. 9D, where three quality streams are ingested, and at frame 5 the quality of stream 1 may drop resulting in a selection of an alternative quality stream. Stream 1 may not be re-selected in later frames in the figure due to the hysteresis filtering described earlier.

In some embodiments, the results of the quality stream arbitration module are sent to the meta-data integration module as shown in FIG. 9A. The meta-data integration module may also ingest the meta-data from streams from the different production process modules. In some embodiments, the meta-data integration module integrates the separate meta-data from one or more streams to optimize the quality of the integrated meta-data stream. For example, the quality assessment module may determine that meta-data from stream 3 should be used instead of stream 1, and one primary purpose of the meta-data integration module may be to perform algorithms that transition between the two meta-data streams without introducing artifacts in the meta-data stream that themselves would generate a poor assessment of quality. For example, in some embodiments, consider a first operator of a production process performing activity-following in a video using a joystick, and a second operator performing the same activity-following process. If there is an abrupt transition between the two meta-data streams in the output meta-data stream that is fed to the production module in FIG. 9A (described later), then the produced video may show a discontinuity in production. In some embodiments the present systems and methods may resolve this by performing a blending algorithm over a time period between the two meta-data streams to produce a single blended meta-data stream. A preferred time period over which the blending occurs may be 5 seconds or less. Examples of blending algorithms shall be described later in this specification. In order to blend the meta-data streams over a time period, then it may have to 1) store the meta-data in a buffer within the meta-data integration module, 2) delay the video using a buffer delay module (shown in FIG. 9A) so that video at one time instant can be processed by the Video Production Module (also shown in FIG. 9A) using meta-data from other time instants, and/or 3) to perform the blending algorithms on the meta-data.

In some embodiments, an example of a blending algorithm is shown in FIG. 9E. In this embodiment, the blending is an algorithm that first generates an intermediate meta-data stream that comprises the first selected stream before the point of transition and the second selected stream after the point of transition, and that second, filters the intermediate meta-data stream to reduce the magnitude of high-frequency components in the meta-data stream. Examples of such smoothing includes averaging, or a quadratic filter as shown in FIG. 9E. In the example, y_t is the meta-data stream value y at time t, and the parameters d,e,f are parameters of a quadratic curve that are recovered by a least squares fit over time of the values y_t. In this example, y_t is the y coordinate of location of activity in the field of view of the camera that an operator has designated using a joystick.

In another embodiment, the present systems and methods may cascade distribution production components such that the output of one distributed production component is the input of a second distributed production component, while still maintaining at the output of the second production component an assessment of production quality that is a function of the first distributed component and the second distributed component. FIG. 9F shows an example implementation of an embodiment of a system for cascading distribution production components. As illustrated in the figure, the production process meta-data and the quality assessment stream data from distribution production module 1 is being transmitted to the production process module 2 in distribution production module 2. For example, the result of activity following performed automatically or manually by Distributed Production Module 1 may be used as an input for graphic overlays performed automatically or manually by distributed production module 2. FIG. 9G shows another embodiment where the results of multiple production modules are fed in parallel to another production module. The ability to configure distributed production modules in series or in parallel is significant since some production processes may require a previous production process to have occurred in order to perform another production process. For example, in one embodiment, audio commentary may best be performed on produced content after the production steps of activity following and graphics overlay are performed, so that the audio commentary relates to what the viewer is observing on the screen and not intermediate or prior video.

In some embodiments, one important aspect is that the assessment of production quality that is output from a first production module is an algorithmic function of the production quality of all the quality assessments of all the distributed component modules that are inputted to the first production module. An example of such an algorithmic function may comprise: identifying the minimum value of all the values of the quality assessments connected as an input to the production module. In this embodiment, if there is a quality problem with a first production module connected as an input to a second production module such that the quality assessment drops, then the quality of the output of the second production module shall also drop even if the actual process being performed by the second production module is of high quality. This may reflect the fact that the overall production quality may be compromised even if just one of the steps of production is of low quality.

In another embodiment, the present systems and methods may edit the output of a distributed production module to correct for errors in production. FIG. 9H shows an embodiment of a system that edits an output of a distributed production module. The modules are the same as, or incorporate similar features to those in the previously-described distributed production module, with the addition of a buffer delay module between the production quality assessment module and the production process module. In some embodiments, the first step in the editing process is triggered if the production quality assessment module determines by manual means or automatic means that the quality of production had dropped below a value as described previously. For example the operator may observe on their computer screen that in fact they were not following the activity correctly with the joystick, and the operator may manually press a button to indicate a low quality of production quality at that time instant which triggers the second step in the editing process. In this embodiment, in a second step the production module accesses the data in the buffer delay module to retrieve and display the data that had previously been presented to the operator. In short, the production module can rewind to using and presenting data from a period at or before it was determined that quality had been compromised. A preferred time period is 10 seconds or less, for example. A third step in the editing process may include that the operator re-performs the original process but correcting the error that had previously been made.

In some embodiments, the present systems and methods may produce high quality video content where the production components are distributed across different people and/or geographically, and where a first production component is being performed at a video frame rate that is greater than the frame rate of one or more production components, subsequent to an editing step being performed by the first production component. A problem being addressed is that when an editing process occurs, a fixed time delay between the input and output data streams is introduced caused by the time it takes for an operator to correct the error. If subsequent errors are made, then the time delays due to errors can accumulate. In this case, eventually the buffer delay module both in the distributed production module and also the video production integration module may not be sufficiently large to accommodate such accumulations in delays. It may also be undesirable to delay the video production. In some embodiments of the present systems and methods, this is resolved by performing the production process in a first distribution module at a video frame rate that is greater than the frame rate of one or more production components, subsequent to an editing step being performed by the first production component. In this way, the time delay gradually can reduce back to zero. In one embodiment, the nominal frame rate is defined as R0. Preferred values of R0 are 15 frames per second for example, in one or more embodiments. The nominal length of the buffer delay module may be L0=15×60×2=1800 frames which corresponds to 2 minutes of data at the nominal frame rate, for example. In some embodiments, the point at which data is being retrieved from the buffer is given by L(t), where t is the moment in time. When no editing has occurred, then L(t)=0, which means that the most recent data is being used for production for example. In an example scenario, when editing that has taken 1 minute has occurred, then L(t)=900 since data is now being accessed from 1 minute before the current time. An example algorithm that increases the frame rate temporarily over time to reduce L(t) back to 0 is: R(t+1)=(R0+K*R(t)*L(t)), where R(t+1) is the new specified frame rate at which the production process is specified to be performed, and R(t) is the previous specified frame rate at which the production process was performed. A preferred example of K in the example embodiment is K=15/(15*900)=0.001111. For example, after an editing step that has taken 1 minute has been completed, then using the algorithm, the new frame rate specified after the error has occurred is R(t+1)=(15+0.00111*15*900)=30 frames per second. This may be twice the nominal frame rate typically used for production and therefore the data being fed out of the buffer delay module may exceed the rate at which data is being ingested into the buffer delay module, so that the value of L(t) (e.g., the location from which data in the buffer delay module is being extracted for production) begins to reduce. As the value of L(t) reduces then the algorithm may gradually reduce the frame rate towards the nominal frame rate R0. In this way multiple successive editing steps can be performed without the accumulation of processing delays.

In another embodiment, the present systems and methods incorporate or operate with a payments system that automatically reimburses providers of distributed production components based on the quality of the produced content from the provider's production component. FIG. 9I shows an example embodiment of a system that incorporates or operates with a payments system. The quality assessments from the distributed production modules that were previously described may be ingested into a quality ingestion module that collects the data and transmits it to a payment arbitration module. The payment arbitration module may ingest data from a database that contains payment data for each remote production process module. For example, a distributed production process that should involve an operator with more skill than that required in another production process may have a higher value for payment. An algorithm in the payment arbitration module may define a payment to the provider of a first distributed production process as a function of both the production quality metadata stream of the first production process, and the payment data for the distributed production process. In one embodiment, an algorithm for defining the payment is P=P0*(AVG(Q(t))/100), where P0 is the payment value stored in the database, 100 is the maximum possible quality value that a service provider could provide, and AVG(Q(t)) is the average of the quality assessment stream (shown in FIG. 9c for example) actually delivered by the service provider, for instance. The payment value P is then transmitted automatically to an accounts payable system (e.g., as shown in FIG. 9I) where payment is provided to the service provider of the distributed production module.

FIG. 9J shows an example of a system that implements the video production. Each distributed production module may comprise a personal computer (PC) computer workstation with a display, a joystick for an operator to interact manually with the display, and a microphone for audio input. The video production integration module may include a PC computer workstation with a display. Video input in FIG. 9J may be provided by a high resolution camera, such as model P1428 provided by Axis P1428. The result of the video production integration module may then be streamed to a viewer using a streaming service, such as YouTube®.

FIG. 9K shows an example embodiment of a system that implements payment aspects. The payment arbitration module is a software module that performs the aforementioned payment determination algorithm on a first PC workstation. The accounts payable system also runs on a second PC workstation that is connected to the first PC workstation. An example of an automated accounts payable software package that can be used as a component in the system is provided by MineralTree.

### Remote Video Production Using Standard IP Networks

The ability to produce broadcast-quality video remotely from an event greatly reduces the cost of deploying personnel and equipment at the site. With remote production, functions that were once done on-site or locally can be performed off-site or remotely so that personnel and equipment can be shared between events, and also without transportation, setup, and tear-down costs for example. Some methods for broadcast-quality remote production have had to use specialized data communication infrastructure between the local and remote locations to minimize to just a few milliseconds the latency or time-delay between the local activity and the remote production functions. Such specialized data communication infrastructures can be expensive and has limited the mass deployment of remote broadcasting.

The present systems and methods are capable of performing broadcast-quality, remote production using standard IP network infrastructure connecting local and remote production functions. This can greatly reduce costs and can enable the deployment of remote production at any event served by a broadband IP network connection. The present systems and methods can address a number of key problems in remote production, including latency and synchronization.

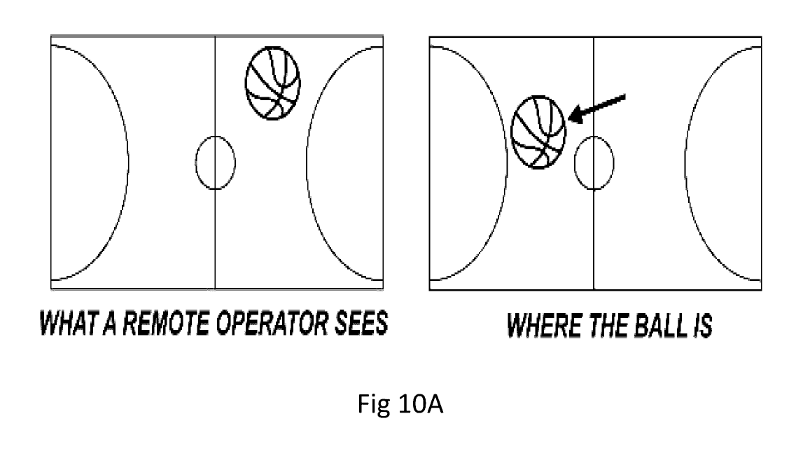

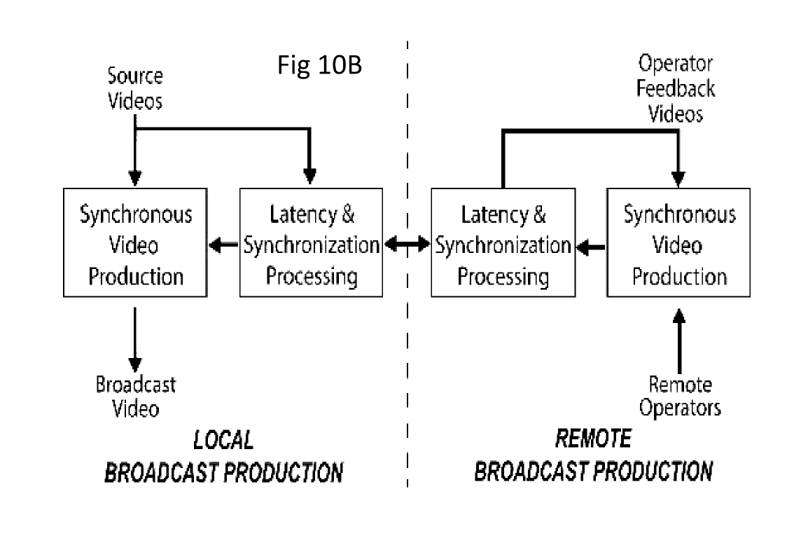

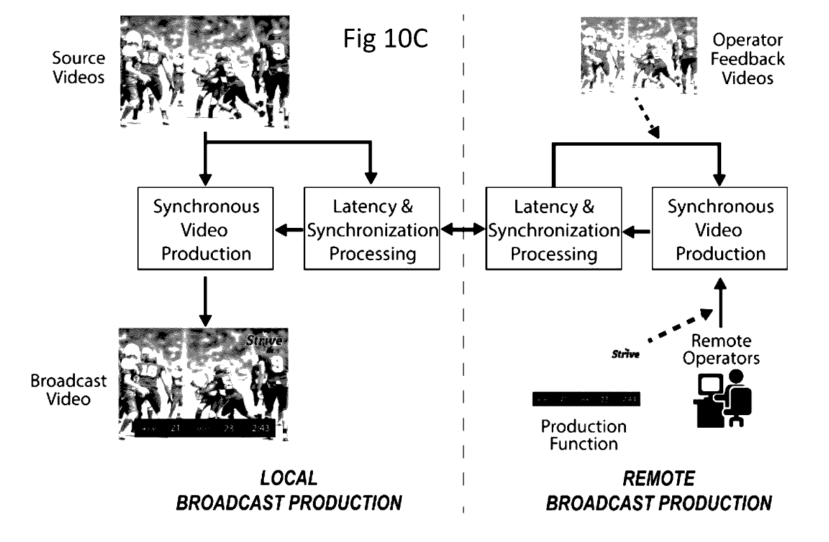

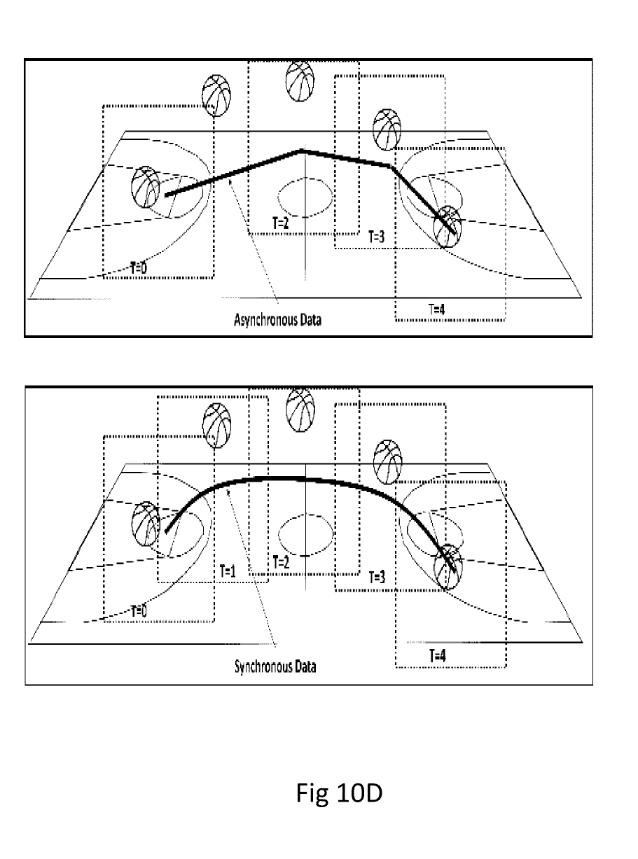

Latency problems can occur due to network delays, such that video data sent remotely is processed at a different time to events that occur locally. FIG. 10A illustrates this problem when using a remote production function that aims to follow a moving ball using remote-control of a camera. On the right of FIG. 10A is shown where the ball is at a moment in time, for example. On the left of FIG. 10A is shown what a remote production operator sees at the same moment in time for example, in the presence of latency between the local event and the remote production; the ball is shown to be in a position from a previous time instant. In some remote broadcast solutions, any real-time remote commands issued to other locations in the presence of such latency is out of date and results in very poor production quality, analogous to the unacceptable quality that even a small delay between audio and video introduces during person-to-person interviews resulting from lip synchronization issues.

Synchronization problems can occur due to unknown variations in the network latency over time such that video sent remotely cannot be synchronized to video locally. Such variations in latency can happen all the time over standard IP networks due to many factors, including usage by other network users. Thus, broadcast production should have video frames to be delivered synchronously for broadcast at a fixed rate per second precisely without fail, while variations in network latency means that remote production data can only be sent asynchronously at varying time intervals.

Some remote broadcasting methods aim to overcome latency and synchronization barriers by deploying custom and specialized data networks. Embodiments of the present systems and methods address these issues by a unique remote production architecture with specific latency and synchronization processing at both the local and remote locations. This architecture is illustrated in FIG. 10B.

### Remote Broadcasting Architecture

Embodiments of the present systems and methods can manage latency and synchronization over standard IP networks using a Cloud LIve Processing (CLiP) architecture or system, an embodiment of which is shown in in FIG. 10C. Local and remote broadcast functions/systems are shown to the left and right of the dotted line respectively, for example. The local system can ingest synchronous, broadcast-quality source videos, shown at the top left. These videos can be processed by a local latency and synchronization module to generate a remote video representation suitable both for transmission over standard IP networks and for a remote operator to perform off-site production functions, as described later. The remote video representation can then be subjected to remote latency & synchronization processing which can ensure that the remote operators (shown at the bottom right) are able to use synchronous video (shown at the top right) for their production functions, as opposed to discontinuous video that stops and starts intermittently, for example. Even minor discontinuities in the fluidity of the video presented to remote operators can significantly impact their abilities to perform quality video production. The outputs of the remote operators' production function (for example, graphic score overlay, as shown on the bottom right) can then be transmitted through the remote latency & synchronicity module to the local latency & synchronicity processing module. This local module can perform several functions described in more detail later, including: (i) asynchronous to synchronous conversion which takes remote asynchronous data inputs, such as camera position or graphic overlay data, and generates synchronous data outputs at the same frame rate as the source videos, (ii) temporal video-caching which aligns temporally the local broadcast function's real-time output with the remote broadcast function output accounting for the temporal latency between the local and remote broadcast functions, and/or (iii) spatial video-caching that accounts for any spatial differences in the regions of interest selected by remote production functions (e.g., as a result of ball-following functions), and the regions of interest computed by the asynchronous-to-synchronous conversion and temporal video-caching. The result is broadcast-quality, produced video, shown at the bottom left.

### Latency & Synchronicity Processing

### Remote Video Representation

The local latency & synchronization processing module can generate a remote video representation that is suitable both for transmission over standard IP networks and for operators to perform remote production functions. The remote video representation can be the result of minimizing video attributes, such as resolution and frame rate, to optimize video transmission over the designated IP network, while at the same time maximizing the ability of remote operators to perform their production functions. For example, a remote ball-following function may typically require a higher frame rate but lower spatial resolution in order to follow rapid changes in activity in the scene, compared to a remote commentary function that typically requires higher resolution imagery but at a lower frame rate to enable the remote operator to identify specific features such as player numbers or identities.

### Asynchronous to Synchronous Conversion

The asynchronous to synchronous conversion module can take remote asynchronous data inputs, such as camera position or graphic overlay data, and generate synchronous data outputs at the same frame rate as the source videos. FIG. 10D illustrates an embodiment of missing remote-ball-following information at T=1 due to a momentary delay in the network. The bottom of FIG. 10D shows the result of interpolating the missing data from surrounding data so that, in this case, ball-following information is available synchronously even if the data arrives asynchronously and intermittently from a remote operator.

### Temporal Video Caching

Temporal video caching aligns the local broadcast function's real-time temporal output with the remote broadcast function's temporal output, accounting for the latency between the local and remote broadcast functions, using sequential video and data buffers. Latency can vary widely depending on network usage and also the geographic locations of the local production function and the remote production functions, but typically varies between less than 100 msecs to 500 msecs on average. Some embodiments of the present systems and methods can provide temporal video caching that manages this latency adaptively such that the temporal difference between the source and produced video data is minimized for any given IP network connection.

### Spatial Video Caching

Spatial video caching can account for any spatial differences in the regions of interest selected by remote production functions (e.g., as a result of ball-following functions), and the regions of interest computed by the asynchronous to synchronous conversion and temporal video caching processes. FIG. 8 shows an example where regions of interest (shown by the rectangles) are enlarged around the scene activity (marked by the solid circles) at 3 different time instants. At the third time instant, the remote ball-following operator or function is still unaware due to latency that at the local site the scene activity has already changed its direction of motion. However, the enlarged region of interest at the third time instant (shown by the dotted rectangle) is still sufficiently large to contain the scene activity. The size of the enlarged regions or spatial cache is determined dynamically by the latency, the speed of activity, and the confidence by which the position of future activity can be predicted from the position of prior activity.

Producing Synchronous Output with Asynchronous Network Conditions

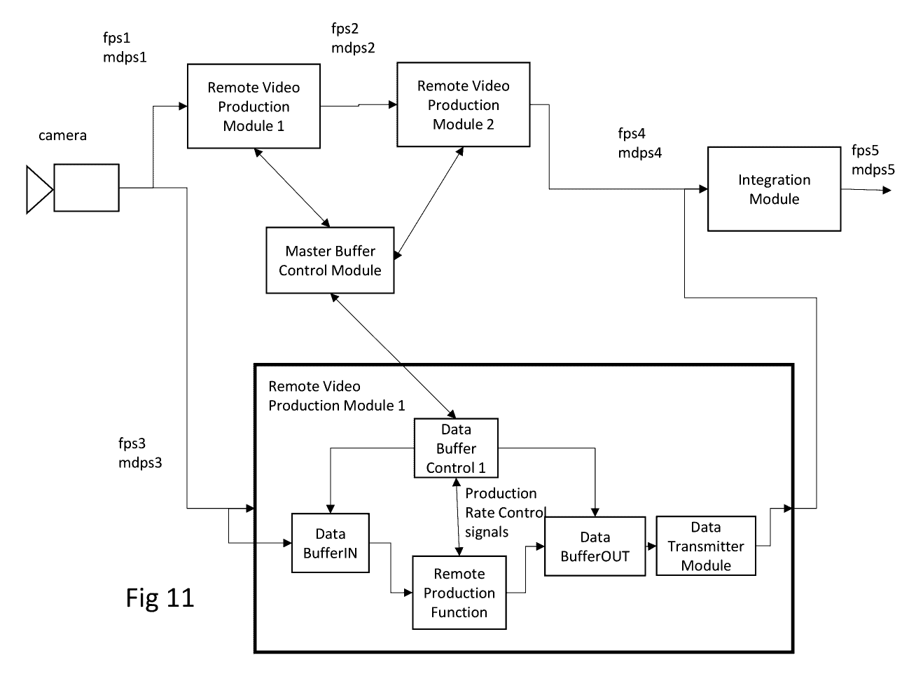

In one embodiment, several remote production modules are distributed and configured depending on their functionality (e.g., ball-following, commentary addition, score addition) to be either serial or parallel, as shown in FIG. 11. In that embodiment, the modules may include PC computers each connected by standard broadband network connections.

One of the remote video production modules is shown in more detail in FIG. 11. It comprises an input buffer (DataBufferIN) module, an output buffer (DataBufferOUT) module, the remote production function itself, and a data buffer control module within the remote video production module. A master buffer control module may connect to all the remotely distributed data buffer control modules. In some embodiments, a Data Transmitter Module within each remote production module transmits video data at faster or slower rate than a preferred frame rate.

In some embodiments, the network connections between the modules may have data latencies, and may be asynchronous, such that the available data rate may increase or decrease momentarily. As discussed previously, there is a need however that the integration module output video data at a constant frame rate, indicated in FIG. 11 as fps5, for example, and also output any metadata (e.g., index of the camera being shown) at a constant rate mdps5. In one embodiment, a Data Buffer IN module ingests data corresponding to each frame of video over the distributed network, and stores each frame of data in a series of memory buffers. In one implementation the buffering method may be a series of ping-pong buffers. The remote production function processes the data from the last memory storage in the buffer. If the input data rate exactly equals the processing rate, then the series of buffers neither overflows, nor runs out of data for the processing module to process. In one embodiment, a buffer control algorithm can control a production rate control signal that can process and transmit data both faster than the preferred data frame rate and slower than the preferred frame rate. If data momentarily does not arrive at an input buffer due to momentary delays or outages of the network, then the size of data in the input buffer can begin to reduce. However when the network is restored, then data may be sent at a higher frame rate than the preferred frame rate. This can replenish the buffer back to the same level so that the buffer is available to accommodate future network outages. Without replenishing the buffer at a high frame rate than the preferred frame rate, then the buffer would be unable to accommodate further data outages.

In one embodiment, the data transmitter module at the output of each remote distributed production module enables video frame rate data to be transmitted faster or slower than a preferred fixed frame rate Fps0, but in a way that ensures that the average frame rate over a given period equals the preferred fixed frame rate. In some embodiments this is accomplished by ensuring that:

Avg(FpsOUT(t))=Fps0

over a time period approximately equal to the size of the output buffer. A preferred value for the size of the output buffer is 5 seconds, for example. Network protocols such as TCP/IP guarantee that data arrives at the next processing module, and this means that any momentary network outage between the output of one distributed production module and the next results in automatic pausing of the data transmission until the network is restored. This is reflected in a delay in the transmission of data, which can be measured and used to measure the instantaneous FpsOUT(t) at any time instant t. Based on the actual measurements of FpsOUT(t) over previous times t−1, t−2, t−3 etc., then the controlled value FpsOUT_y of FpsOUT at the next time instant in some embodiments may be:

FpsOUT_y(t+1)=Fps0+K2×(Fps0−Avg(FpsOUT(t),FpsOUT(t−1),FpsOUT(t−2),FpsOUT(t−3),FpsOUT(t−4), . . . ))

where K2 is a gain factor that controls the rate at which the controlled value of FpsOUT changes over time in response to momentary outages in network connectivity. A preferred value of K2 is 0.1, for instance. In this embodiment, if the average of the measured output frame rate over the previous time is less than Fps0, then the control value of FpsOUT_y(t+1) is set to be greater than Fps0 in order to compensate for the deficiency in data. If the average of the measured output frame rate over the previous time is greater than Fps0, then the control value of FpsOUT_y(t+1) is set to be smaller than Fps0 in order to compensate for the overflow of data.

In another embodiment, the rate control signal for a first remote distribution module at any time t can be defined as Fps1(t). If Fps0 is the preferred frame rate, then in one embodiment, an algorithm for controlling the processing rate may be:

Fps1(t)=Fps0+K*(Avg(FpsIN(t))−Fps0)

where Avg(FpsIN(t)) is the average of the sum of the frame rate input into the module over a period of time corresponding approximately to the size of the input buffer. In some embodiments, a preferred size of the input buffer is 5 seconds, for instance. The value of K is a gain factor that controls the rate at which the control signal changes in response to variations in the data rate of the network.

If K is greater than 0 (a preferred value is 0.1) then if FpsIN(t) falls below Fps0 at any time instant t, then the processing rate Fps1(t) reduces. On the other hand, upon restoration of network connectivity, then FpsIN(t) may increase above the value of Fps0, and the rate of processing may increase above the value of Fps0.

### Automatic Video Production

In some aspects, the present disclosure is directed towards systems and methods of improving quality in video production. Some embodiments of the present systems and methods may use sparse, aperiodic, intermittent or asynchronous user input specific to only certain image frames, for example, to determine scenes from available image frames to include in a video being produced. Methods and apparatus are described for performing effective automatic or semi-automatic video production using video clips acquired from one or more camera sources over a time period. In some embodiments, different points of interest in the video clips are each the focus of different video productions, each video production comprising different portions of the video clips from the different sources at different time intervals. In some embodiments, the source video clips are processed using methods that generate very high-quality video products.

A video camera can acquire imagery containing many points of interest. Example points of interests may be basketball players, the ball, or a particular person running a marathon. More than one camera may acquire imagery of the points of interest. The multiple cameras may acquire imagery of the same points of interest at the same time from different viewpoints, such as cameras at each end of a basketball game court, or they may acquire imagery of the points of interest at different times, such as cameras positioned along a marathon course. In some applications it is useful to view a point of interest consistently over a time period. For example, for after-action review, a basketball player may only want to view close-up imagery of themselves over an entire game in order to assess their performance, and a marathon runner may only want to view video of themselves as they complete the course. Generally, if there are C cameras recording an event and P points of interest at a frame rate of F frames acquired per second, then the number of potential points of interest in the images is C×P×F. In an example, if C is 10, P=20, F=30, then there are 6000 potential observations of points of interest each second. In addition, the final produced video has to be extremely high quality. There is a need therefore for automatic or semi-automatic methods for performing video production.

According to some embodiments, a list of a first type is generated, said list comprising a sequence of records, each record comprising a camera ID, a point-of-interest ID, a temporal position coordinate with respect to recorded time, a spatial position coordinate with respect to the camera image, and a quality of view metric for the point of interest.

According to some embodiments, a means is provided for performing a search through one or more lists of the first type to identify and group records with the same point of interest ID from the one or more lists of the first type, to generate a plurality of lists of a second type wherein each list of the second type comprises records where the point-of-interest ID is the same.

According to some embodiments, a means is provided for sorting the records in each of one or more lists of the second type with respect to the temporal position coordinate to generate a plurality of lists of a third type.

According to some embodiments, for any records of the third type with the same temporal position coordinates, a means to determine from those records the record with an optimal quality of view metric to generate a sequence of records of a fourth type with optimal quality views.

According to some embodiments, a means is provided for modifying the order of records in the sequence of records of the fourth type based on the camera ID number and using hysteresis based on one or both of the temporal coordinate or based on the value of the quality metric, to generate a list of a fifth type.

According to some embodiments, a means is provided for interpolating or extrapolating, for at least one or more lists of the fifth type, one or both of the temporal position coordinates of a point of interest in one or both forwards or backwards directions in recorded time, or the spatial position coordinates of a point of interest, to generate one or more lists of a sixth type comprising a sequence of camera IDs, interpolated or extrapolated temporal position coordinates, or interpolated or extrapolated spatial position coordinates of a point of interest.

According to some embodiments, for at least one or more lists of the sixth type, a means is provided to generate a sequence of views of a point of interest based on the camera IDs, interpolated or extrapolated temporal position coordinates, or interpolated or extrapolated spatial position coordinates of a point of interest.

According to some embodiments, the IDs of the points-of-interest in the sequence of records in the list of the first type are non-contiguous, and the temporal position coordinates are irregularly-sampled in time.

According to some embodiments, the method for extrapolating or interpolating spatial position coordinates of the point of interest is an extrapolation or interpolation algorithm that produces regularly-sampled temporal position coordinates with respect to recorded time.

According to some embodiments, the method for extrapolating or interpolating the temporal position coordinates of the point of interest is based on the expected speed of the object of interest in the camera image. According to some embodiments, the view of a point of interest is generated by selecting a subset of the camera image based on the extrapolated or interpolated spatial position coordinates of the point of interest to generate a camera sub-image. According to some embodiments, the temporal position coordinate with respect to recorded time of a point-of-interest ID in a sequence is computed by determining from the camera image the temporal position coordinate at which a unique characteristic of the object of interest is detected.

According to some embodiments, the temporal position coordinate with respect to recorded time of a point-of-interest ID in a sequence is computed by determining when a stationary proximity sensor is proximate to a moving proximity sensor mounted on the object of interest.

According to some embodiments, the method for entering and then extrapolating or interpolating spatial position coordinates of the point of interest includes a GUI that displays the entered, extrapolated or interpolated spatial position coordinate, and has a means to manually modify the entered, extrapolated or interpolated position coordinate.

According to some embodiments, the method for entering and then extrapolating or interpolating spatial position coordinates of the point of interest includes a GUI that displays the entered, extrapolated or interpolated spatial position coordinate for two or more points of interest on the same camera view, and has a means to manually modify the entered, extrapolated or interpolated position coordinates.

According to some embodiments, the method to manually modify the entered, extrapolated or interpolated position coordinate is to drag the entered, extrapolated or interpolated position coordinates to a different spatial location, and to re-compute and re-display the entered, extrapolated or interpolated position coordinates

According to some embodiments, the method to manually modify the extrapolated or interpolated position coordinate is to delete an entered coordinate and to re-compute the extrapolated or interpolated position coordinates

According to some embodiments, the quality metric for a point of interest in a camera view is determined by the direction of travel of the point of interest.

According to some embodiments, the direction of travel is computed by comparing the actual, interpolated or extrapolated spatial position coordinate at a first temporal coordinate position in recorded time for a point of interest, to a second temporal coordinate position in recorded time for a point of interest.

According to some embodiments, the quality metric for a point of interest in a camera view is determined by the estimated pixel size of the point of interest in the camera view. According to some embodiments, the quality metric for a point of interest in a camera view is determined by the selection of a region in the image in the same or different camera view. According to some embodiments, the determined quality metric for a point of interest in a camera view is modified by a random component. According to some embodiments, the synthesized video sequence switches between source video clips with a minimum value of time between switches. According to some embodiments, the synthesized video product comprises regions of interest that are spatially fully contained within source video clips while adhering to a model of virtual camera motion.

According to some embodiments, the model of virtual camera motion is that a measure of rapid temporal change in virtual camera motion is below a threshold. According to some embodiments, the measure of rapid temporal change in virtual camera motion is the absolute value of the acceleration of the virtual camera. According to some embodiments, the model of virtual camera motion is that a measure of the magnitude of virtual camera motion is below a threshold.

According to some embodiments, the measure of magnitude of virtual camera motion is the amplitude of the instantaneous velocity of the virtual camera. According to some embodiments, the synthesized video product comprises video clips that are processed using directional blur filters based on the velocity of the virtual camera. According to some embodiments, the velocity of the virtual camera comprises the magnitude and direction of the virtual camera. According to some embodiments, a log records at least the duration of the video used in one or more produced video edits.

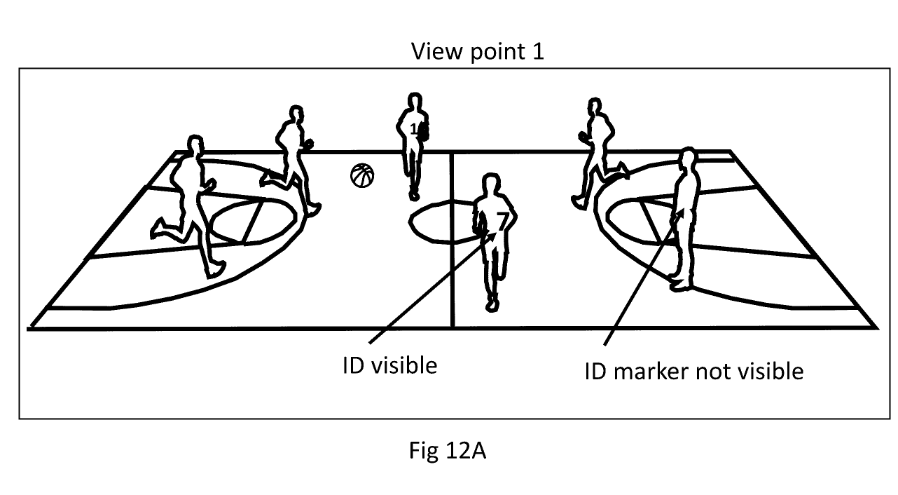

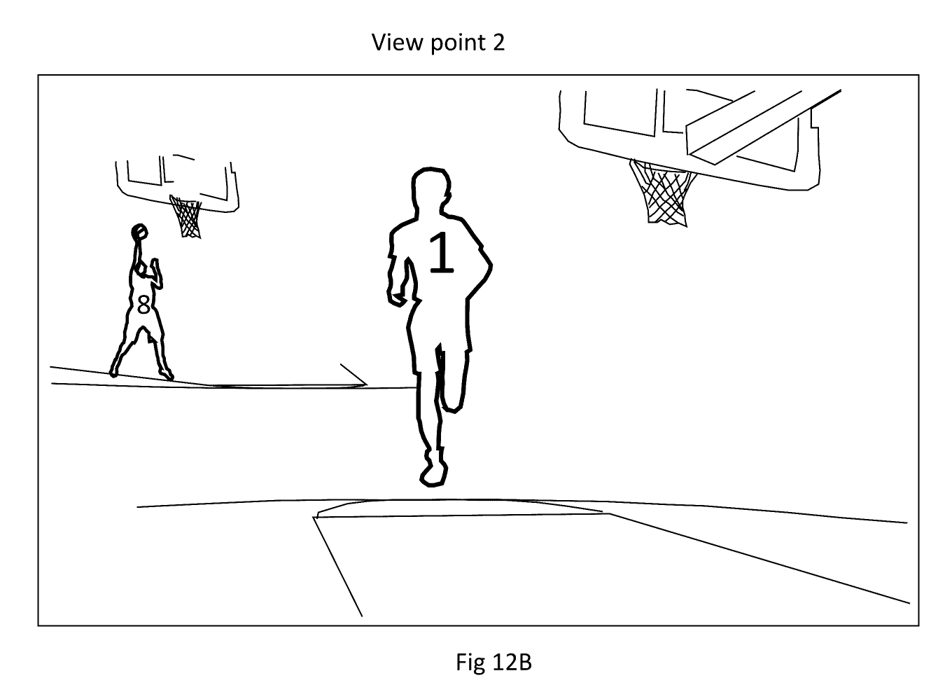

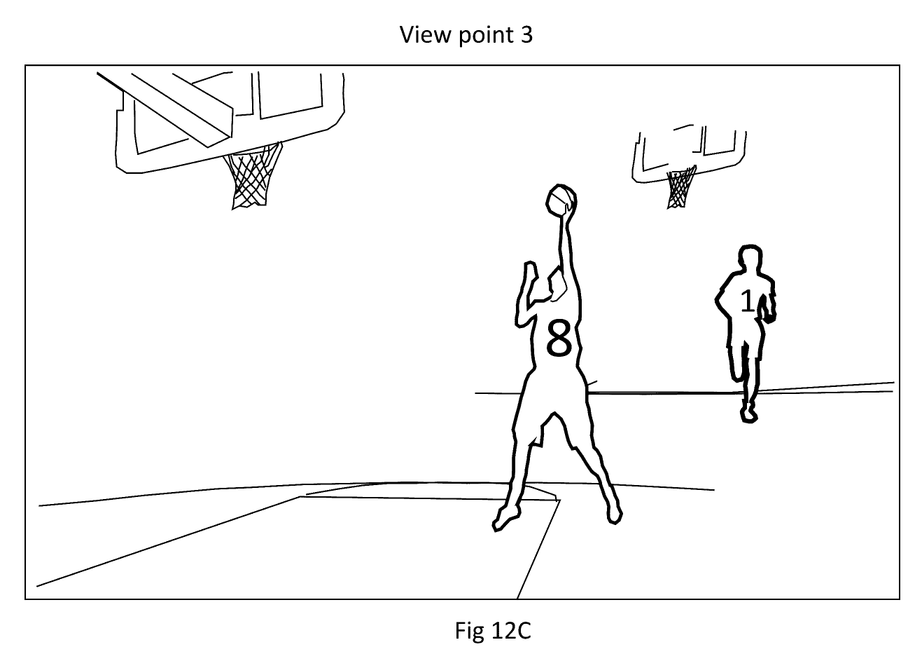

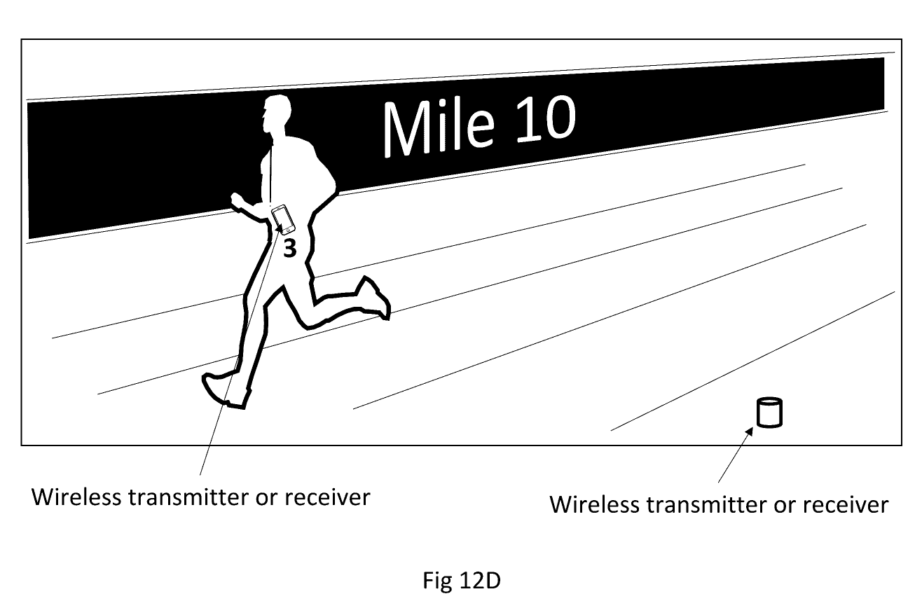

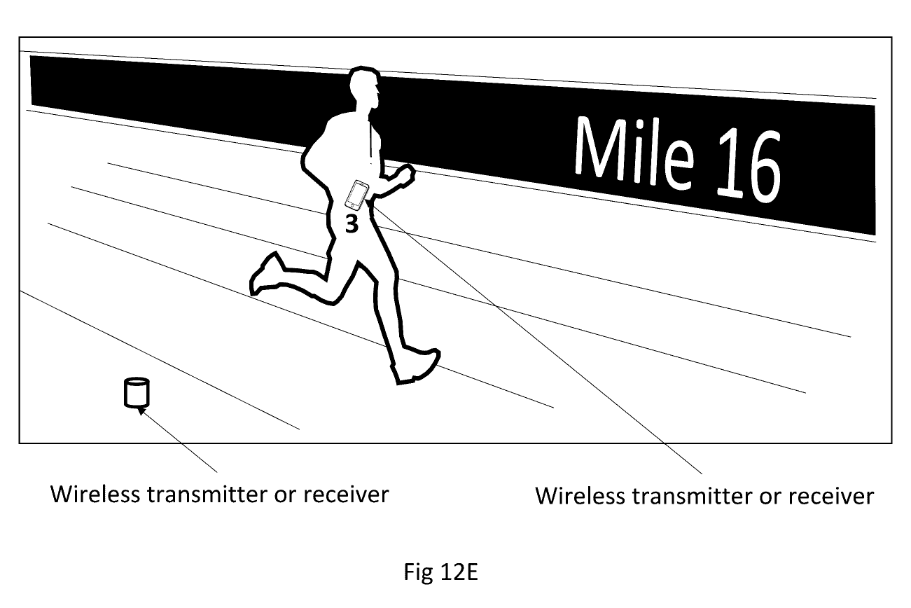

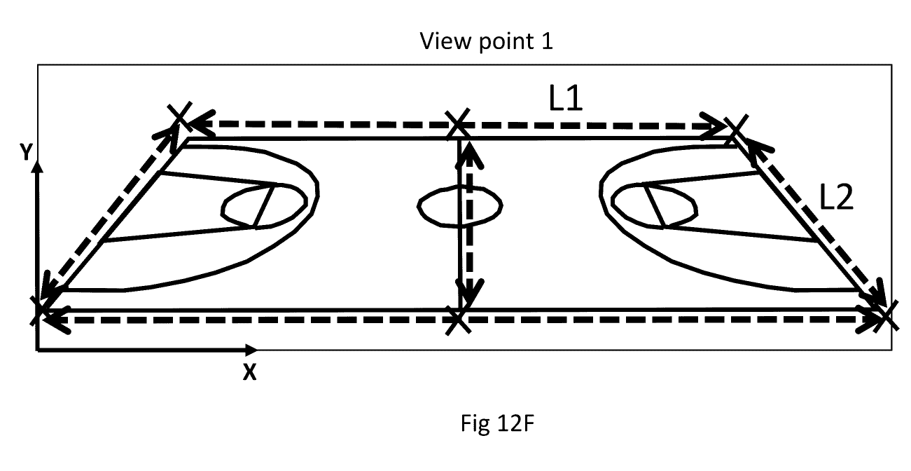

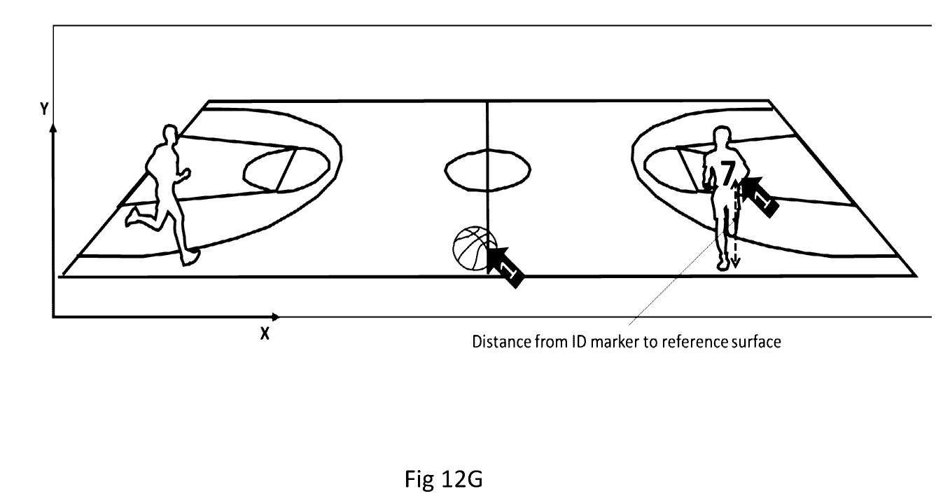

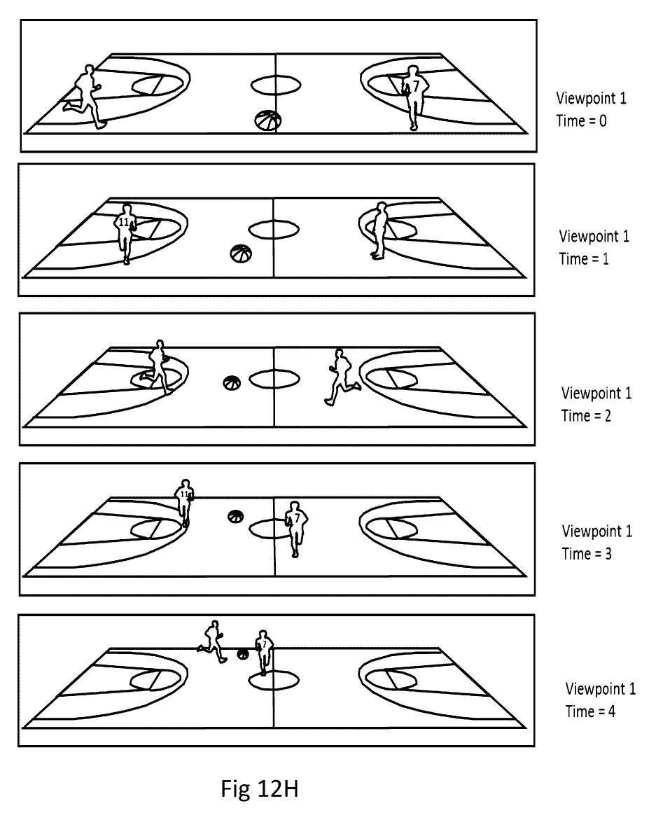

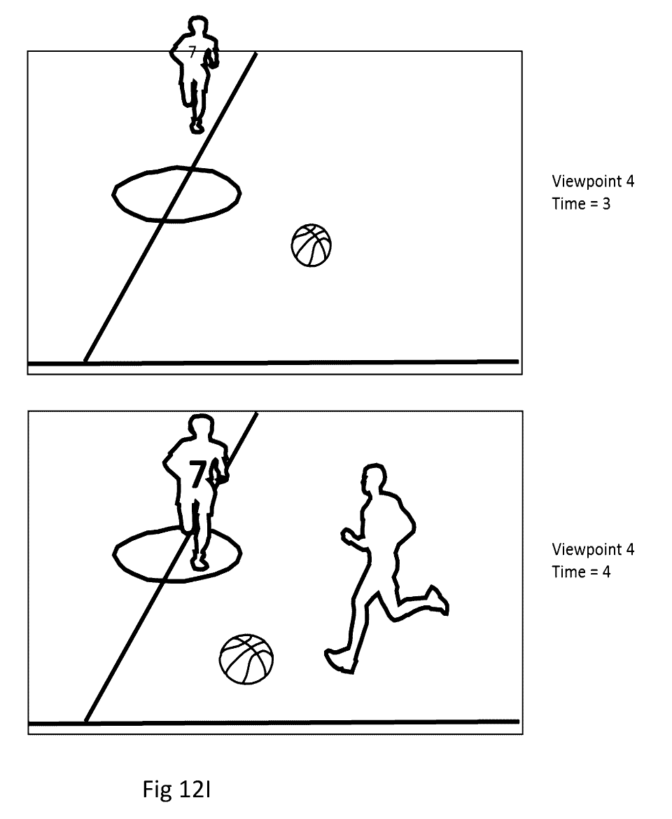

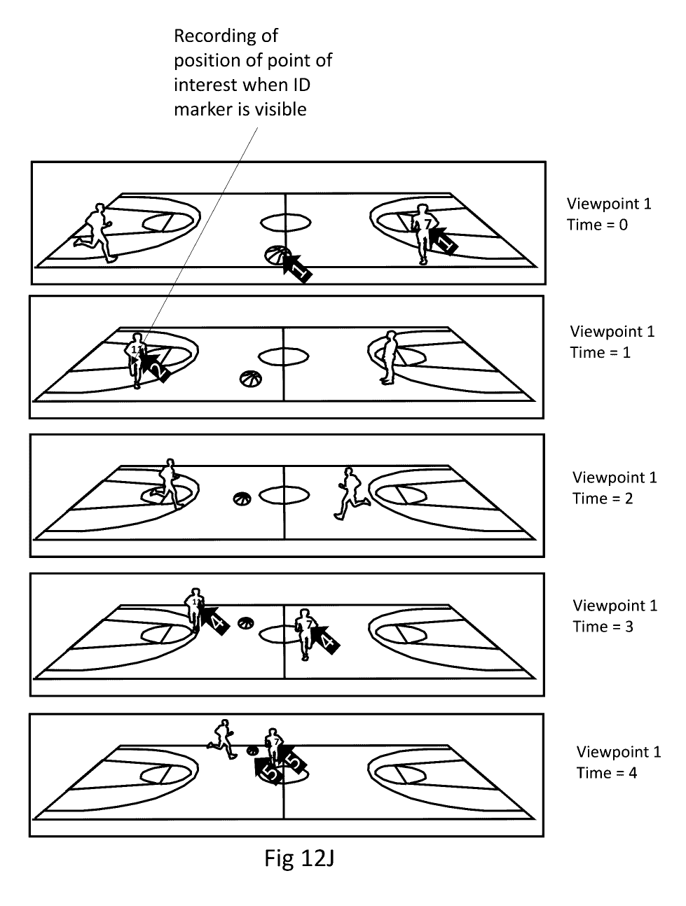

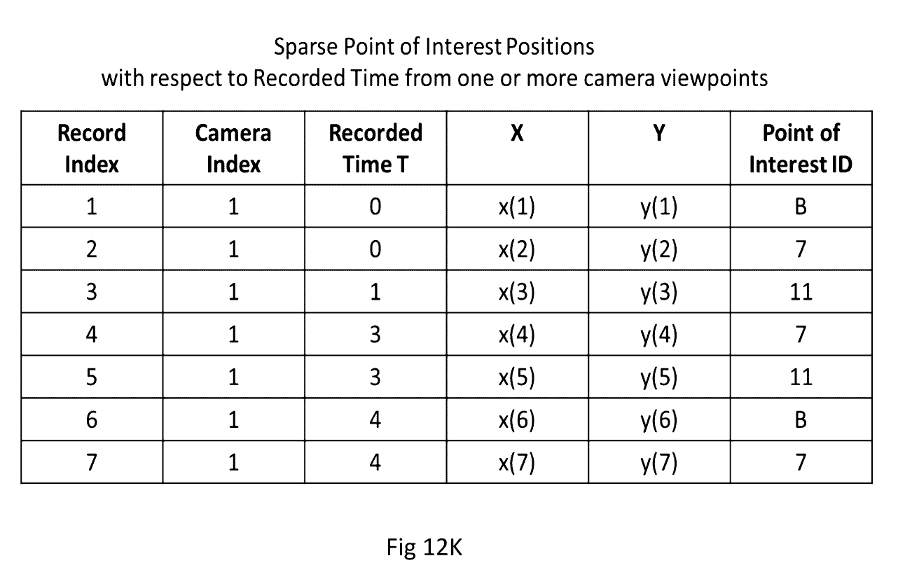

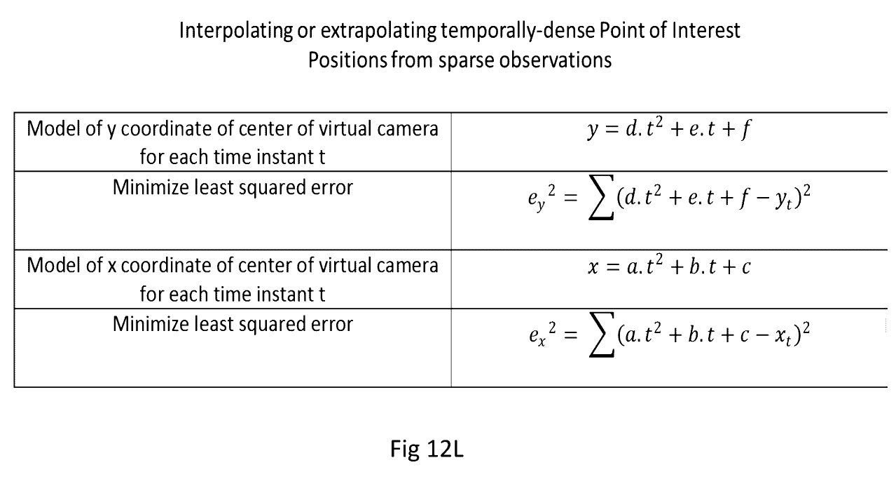

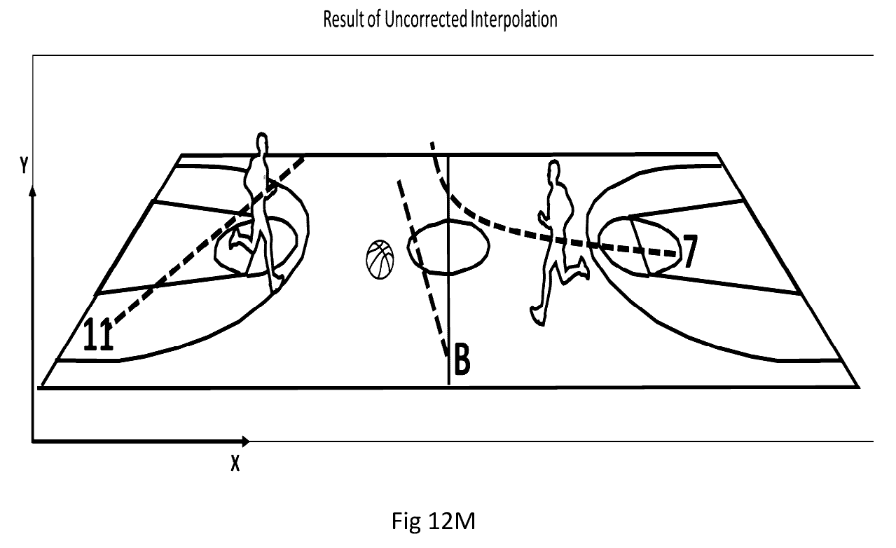

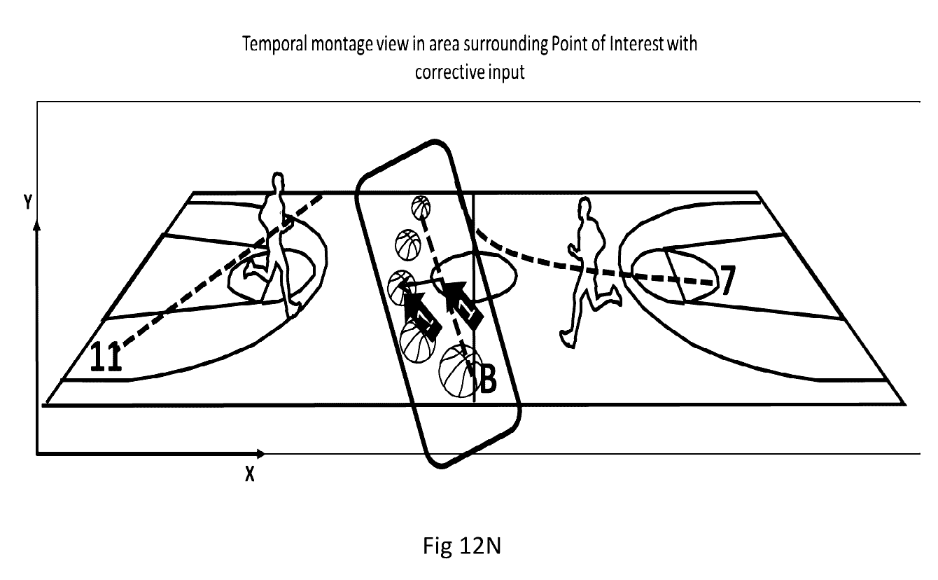

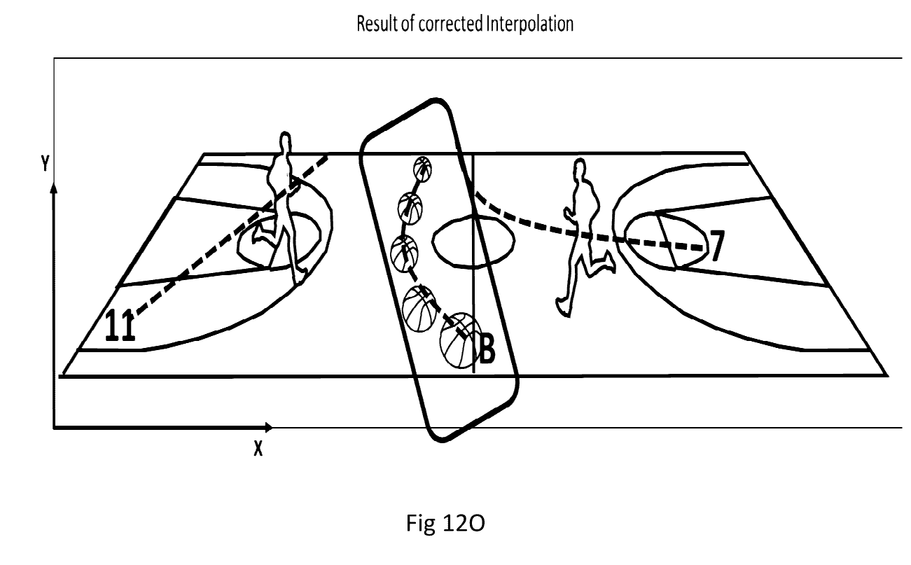

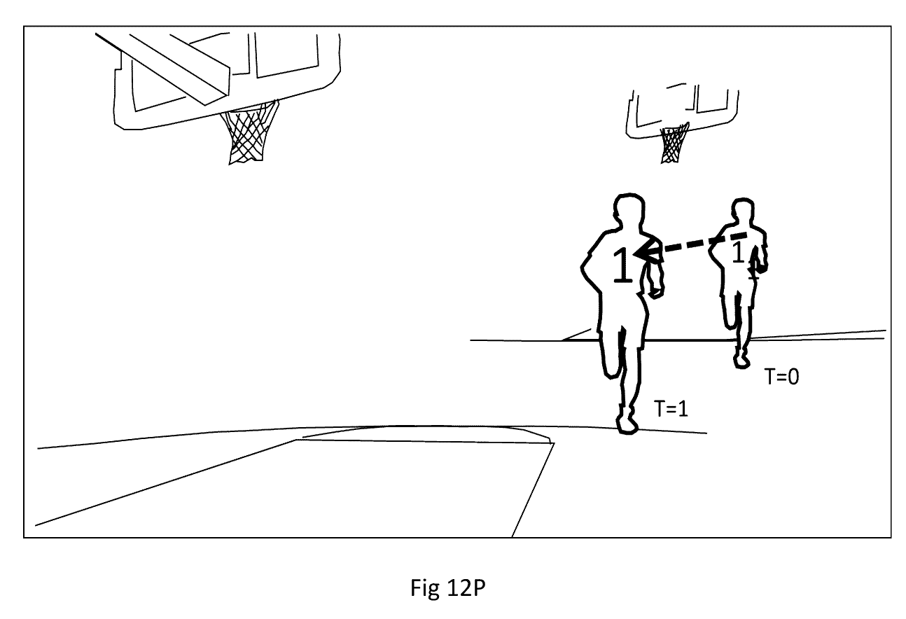

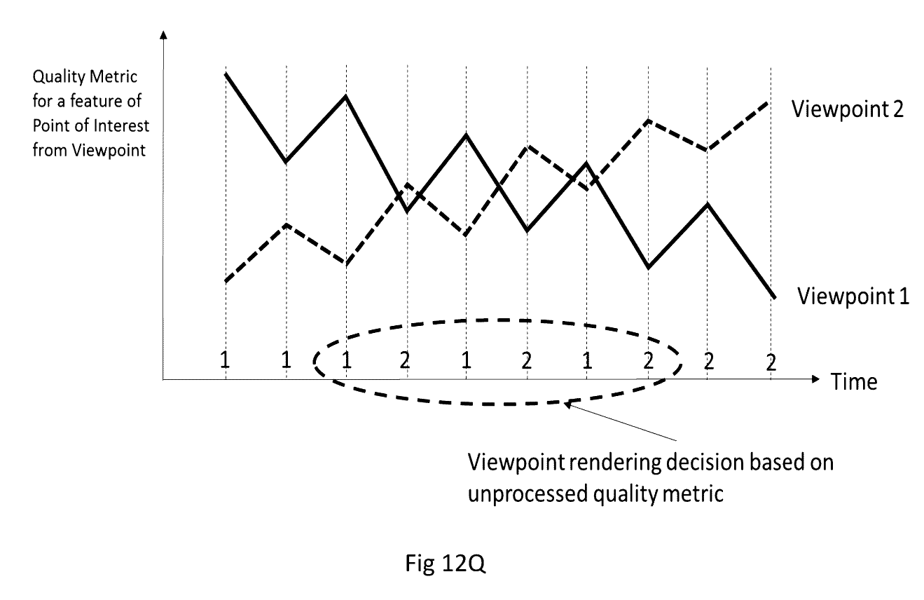

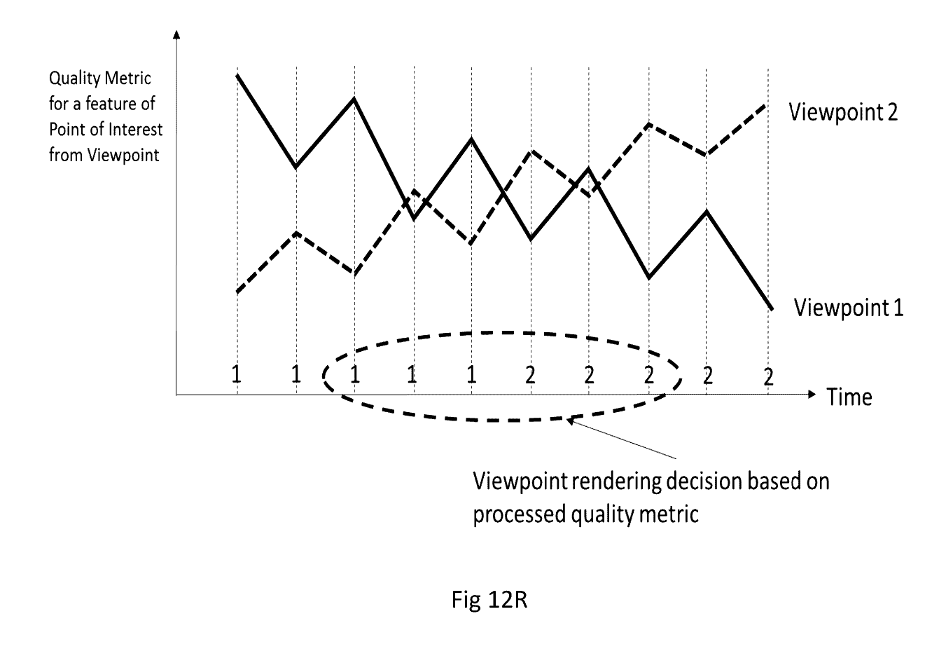

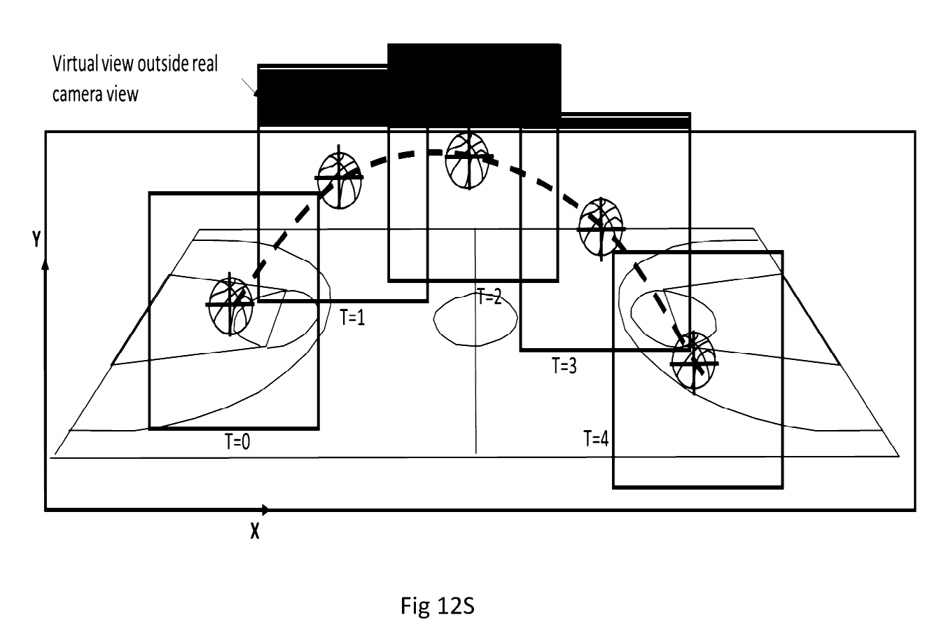

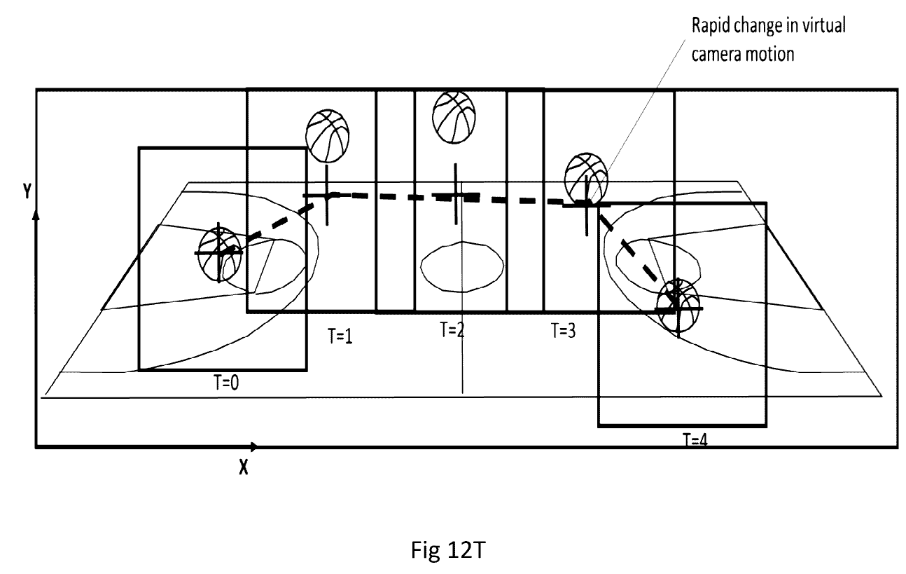

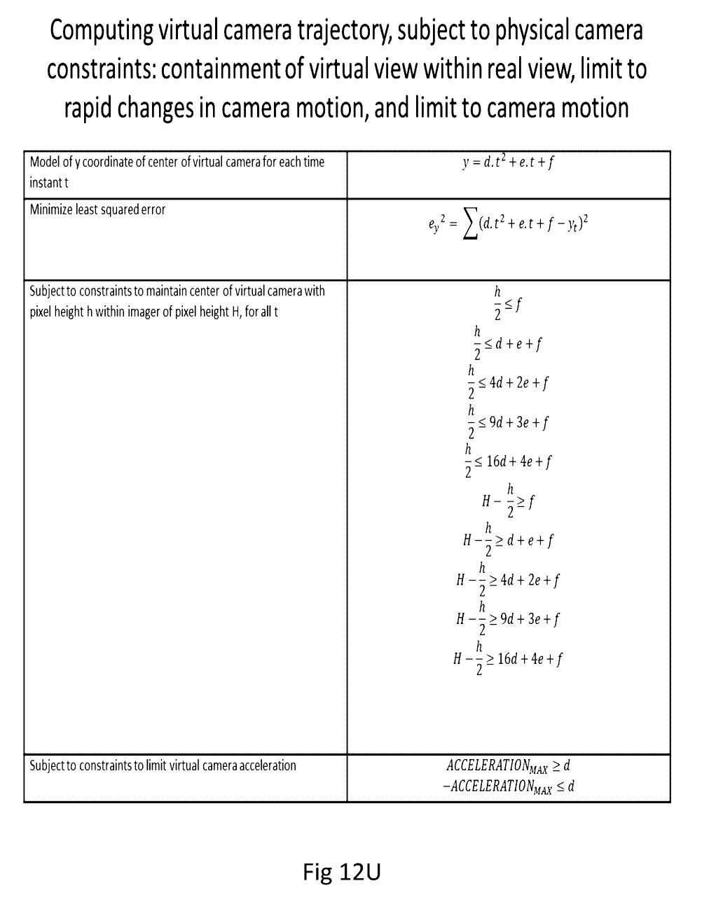

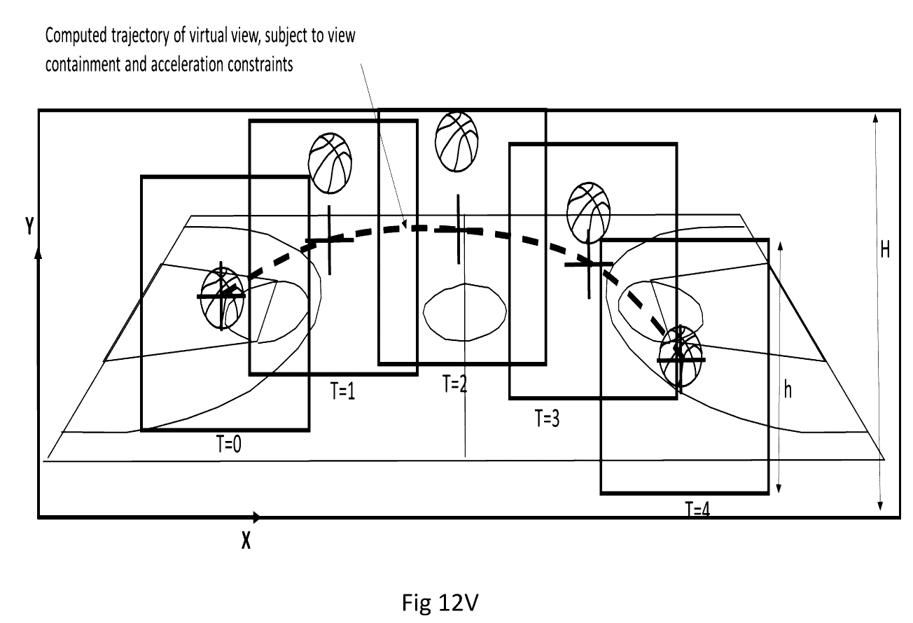

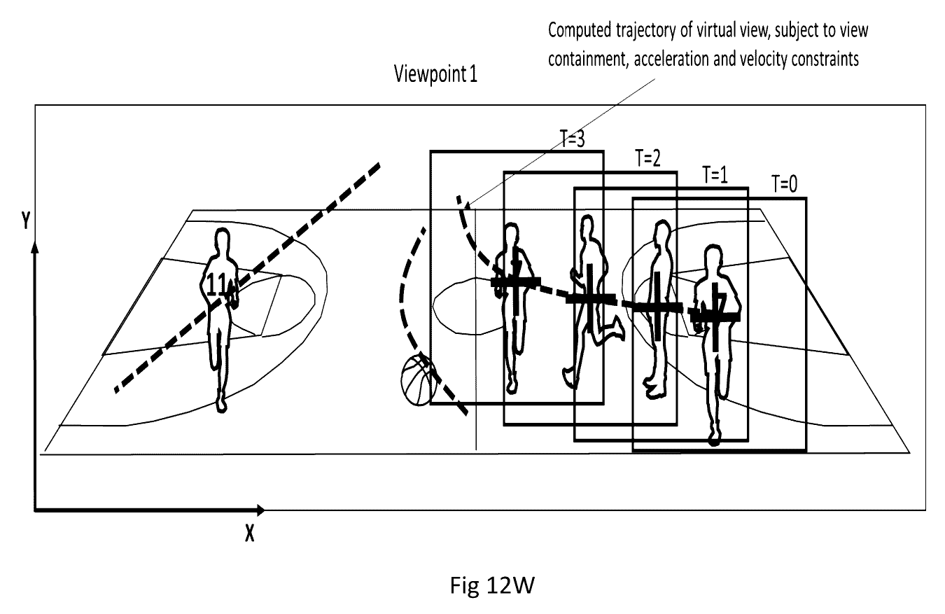

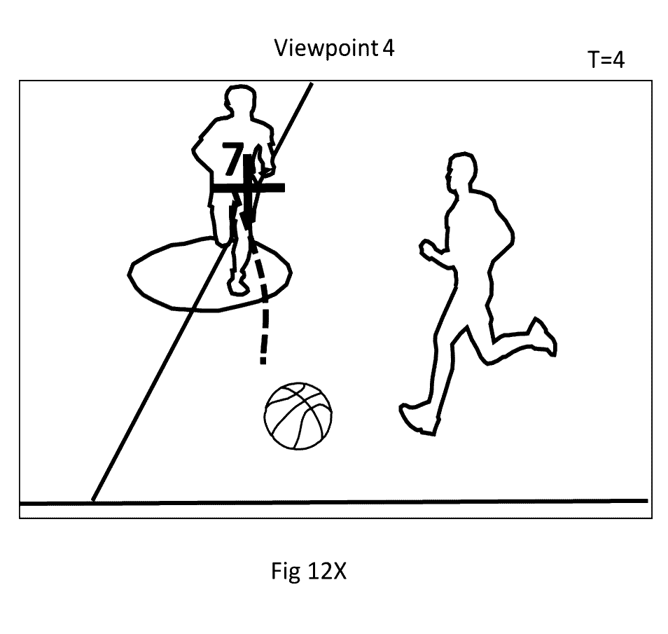

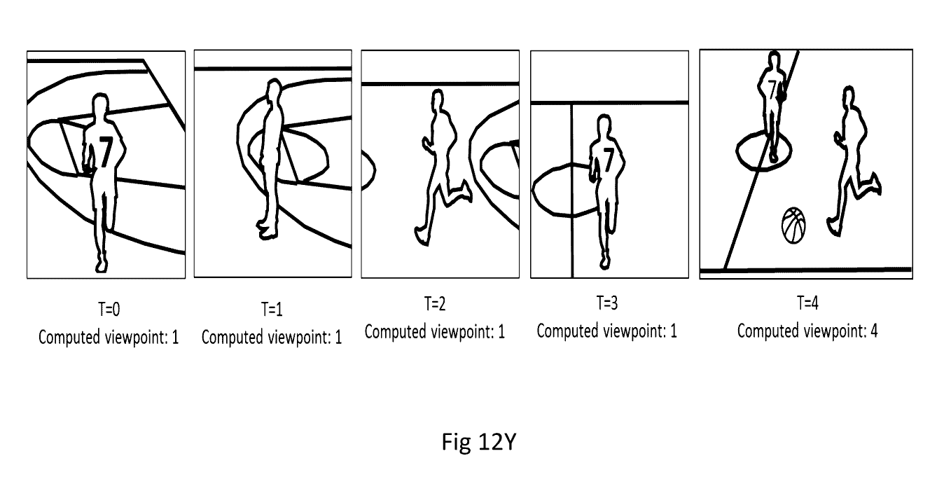

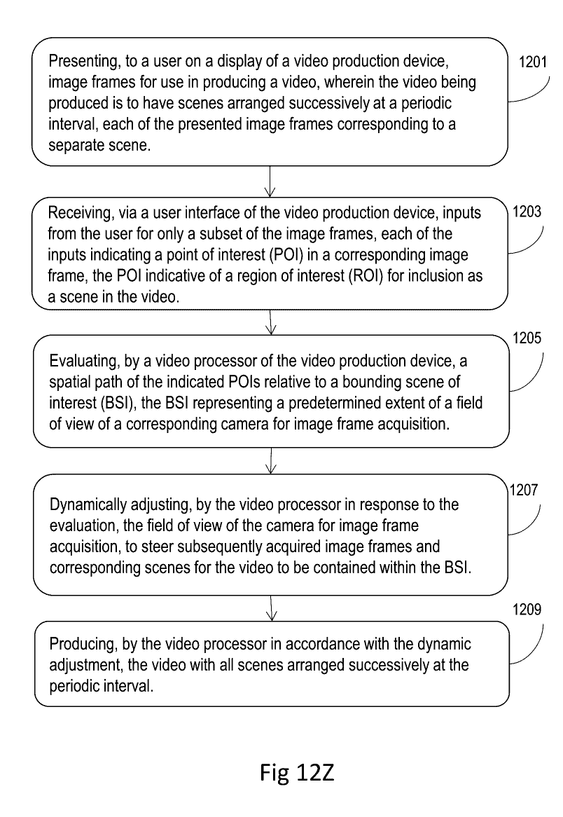

FIG. 12A-12C show 3 separate views of a basketball game. In some embodiments, identification (ID) markers or tags are assigned to points of interest in the imagery. The efficiency of the ID assignment can be important, since the number of points of interest in the acquired videos increases multiplicatively based on the number of cameras and number of points of interest.

In general, when there are multiple cameras acquiring video of multiple participants (or points of interest—POIs), then the different scenarios may include:
Case 1: One or more POIs are visible in a single camera view at the same time
Case 2: One or more POIs are visible in multiple camera views at the same time
Case 3: One or more POIs are visible in multiple camera views at different times

FIG. 12A shows an example of Case 1 (multiple POIs in the camera view at the same time) for a basketball game. In many instances, particularly in sporting events, participants wear unique identification (ID) numbers on their clothing. However these numbers are often not visible all the time. For example FIG. 12A shows that only players “7” and “11” are identifiable in this particular video frame since they are running away from the camera and therefore the player numbers on the backs of their shirts are facing the camera. The other players however are running or standing laterally with respect to the camera view, and their ID numbers are not readily visible.

FIGS. 12B and 12C together show an example of Case 2 (multiple POIs in multiple camera views at the same time) for another basketball game. In this case, each camera is positioned at either end of the court. While the POIs are visible in each view, the quality by which the POI is displayed is different in each case. For example, in FIG. 12C, player “1” is visible but only at a distance and far from the camera.

FIGS. 12D and 12E together show an example of Case 3 (single POI in multiple camera views at different times) for a marathon running event. In this case the cameras are positioned at different mile-markers.

Video of an event may be provided by the public or by an organized production team, and the video acquired may comprise a priori unknown combinations of Case 1,2 and 3.

In some embodiments, the ID of each POI in each frame of acquired video is determined. As discussed previously, the number of POIs can grow multiplicatively with the number of participants in video as well as with the number of cameras. The present methods can assign the ID of the POIs in each frame using efficient methods that reduce the time to perform the task to manageable levels.

FIG. 12D shows one example of one embodiment of an automated method. In this case, a participant (and POI) is wearing a mobile phone that in turn in executing a software application that detects wirelessly whether it is proximate to a sensor positioned near the camera. The sensor may be a low-power Bluetooth sensor (such as the SimpleLink sensor manufactured by Texas Instruments Inc.) that may broadcast a unique ID. The mobile application may store and upload a record to a server dynamically, wherein the record may comprise at least a unique ID for the mobile phone, the unique ID of the sensor, and the time at which the sensor was detected.

In another example of the automated method in FIG. 12D, a pattern recognition algorithm performed on a computer connected to the camera acquiring the video processes the video to detect the ID number pinned to the runner's clothes. An example of algorithms for performing detection are provided in “Pattern Recognition and Machine Learning”, Chris Bishop, Springer 2007.

In some embodiments, the computer then uploads a record to a server dynamically, where the record may comprise at least the detected number of the runner, a unique ID for the camera, and the time at which the video with the detected number was acquired. In some embodiments, the method determines efficiently not only the unique ID of a point of interest in the scene, but also determines attributes of the points of interest. Attributes may include assessments of the speed, 2D position (in image coordinates) or 3D position (in world coordinates) of each point of interest in the scene. The method can determine these attributes efficiently, and may then use them to automatically edit the acquired videos to synthesize produced video.

A first useful attribute may include the 2D and/or 3D position of the POIs in each acquired video scene. An estimate of the 3D position of a point of interest may be particularly useful since it allows assessments of 3D distances and sizes, which may be used by the method for determining a quality metric of the view of a point of interest from a particular camera position. The method may then use this quality metric to determine which camera view to use at a particular time in a produced video edit, as discussed later.

FIG. 12F shows a first step in one embodiment of the method for estimating the positions of POIs. A user may click on points and lines in the camera view and the 2D x,y image coordinates of each point or the line parameters represented by a gradient m, and an offset c may be stored. Then any known 3D distances between points may be stored. In a sporting event, the dimensions of the court (indicated by L1 and L2) may be known a priori from the rules of the sport, and these dimensions may be entered directly without the requirement of performing any 3D measurements. After the points and parameters are recorded, a calibration algorithm may be performed. An example of such an algorithm is Tsai, Roger Y. (1986) “An Efficient and Accurate Camera Calibration Technique for 3D Machine Vision,” Proceedings of IEEE Conference on Computer Vision and Pattern Recognition, Miami Beach, F L, 1986, pp. 364-374. This algorithm can use the points and/or line parameters, as well as the dimensions, and computes the complete camera transformation parameters for the sensor and lens combination. This can recoversparameters such as the field of view of the lens, for example.

In a second step in the embodiment of the method, a reference 3D surface on which participants would primarily be situated may be identified in the scene. This may be performed by a user selecting points in the scene as in the calibration step, and may use a subset of the same points used in the calibration stage. In some embodiments, a flat 3D plane model is fit to the points. An example of such a 3D plane fitting is R. Kumar, P. Anandan, and K. Hanna, “Direct recovery of shape from multiple views: A parallax based approach,” in Twelfth International Conference on Pattern Recognition (ICPR'94), (Jerusalem, Israel), vol. A, pp. 685-688, IEEE Computer Society Press, October 1994.

FIG. 12G shows how in one embodiment the calibration and the ground plane may be used in determining a position attribute for a POI. An operator may click on the number of the player. The operator may have entered beforehand the expected distance of the player's number above the ground plane. Different players may have different expected distances, typically correlated with actual height of the player, although a single average distance is typically sufficient. The method then computes the intersection of the 3D vertical line (through the 2D position of the player's number) with the 3D plane identified in the previous step, to compute attributes such as the actual distance in physical units (e.g., meters) of the height of the player's number above the ground. This along with the camera calibration parameters computed in the earlier step can be used to compute a quality measure of pixel-per-meter on the POI. POIs that are further away from the camera will have a lower pixel-per-meter value. POIs that are recorded on cameras with a higher resolution than other cameras, or on a camera that is zoomed in compared to other cameras would have a higher pixel-per-meter value. As discussed later, this quality metric is one of several that may be used to determine which video source to use in a produced video edit at any particular time.

The method above showed how in one embodiment the calibration and the ground plane may be used in determining a position attribute for a particular camera view for a POI using a 3D model, for example, of the ground plane. The same method can be repeated for each of a plurality of camera views so that a position attribute for each camera view can be determined for a POI using the same 3D model. In one embodiment, an additional capability of the processing is to compute the position attribute in a second camera view for a POI that has been defined by a user in a first camera view. In the embodiment, the constraint is used that it is the same scene (for example a basketball court) that is being viewed by each camera view except it is being viewed from different spatial locations. By using the 3D model of the scene (for example the floor of the basketball court) then the coordinate transformation that maps the first camera view to the second camera view can be computed using, for example, the same 3D planar recovery model described earlier, for example, R. Kumar, P. Anandan, and K. Hanna, “Direct recovery of shape from multiple views: A parallax based approach,” in Twelfth International Conference on Pattern Recognition (ICPR'94), (Jerusalem, Israel), vol. A, pp. 685-688, IEEE Computer Society Press, October 1994. Once the 3D parameters of this transformation are recovered between all possible combinations of camera views in the calibration step, then if a user clicks on a POI in a first camera view while the system is in operation, then the position attribute in the second, third and any other camera view can be computed automatically from the 3D transformation parameters and the pixel coordinates (or position attributes) of the POI in the first camera view. Using this method the user may then only need to define a POI in a first camera view, and the system can automatically compute corresponding POIs and therefore the corresponding quality metrics in all other camera views. The computed quality metrics from each camera view can then be used to determine which camera view is superior for use in the final broadcast video output at any moment in time, as described above, even though the user only entered in a POI in a first camera view.

FIG. 12H shows 5 sequential frames acquired at time instants T=0,1,2,3,4 of a basketball game acquired from a first camera C1 positioned on one side of the court, acquiring a complete view of the court. FIG. 12I shows 2 sequential frames acquired at time instants T=3,4 from a second camera C3 positioned on the other side of the court, acquiring more zoomed in imagery of the same game. FIG. 12J shows one embodiment of the method where an operator clicks on POIs at time instants when their unique ID (e.g., the player number) is visible. Each time the operator clicks, the operator may also enter in the player number on a keyboard or recite the player number verbally. An automatic voice recognition system, such as the Dragon Voice recognition system manufactured by Nuance Inc., can then used to transcode the speech into a text label.

FIG. 12J shows one example of the sparse data recorded using an embodiment of these methods. In this example the camera viewpoint (or ID), recorded time, x and y positions of the POI, and the ID of the point of interest are recorded. As discussed previously, the ID of POIs are not visible in every frame. But conversely, the ID of multiple POIs may be visible in each frame. It is highly inefficient to play through the video P times to assign the identity and attributes of P points of interest throughout the video. The method efficiently enables the assignment of multiple identities and attributes with a single review of the video, as is now discussed in more detail.

In one embodiment, the method interpolates or extrapolates the unknown positions of POIs in frames from measured positions of POIs in other frames. One method for interpolation or extrapolation is to perform a line or curve fit between the 2D coordinates of the clicked point, and to interpolate positions along the recovered line. The same process may be performed using 3D coordinates of the player as computed earlier. FIG. 12L shows a method for performing the interpolations. In this example a parabolic model of each of the x and y positions of each POI over a time period may be used. The parabolic model has 3 parameters for the x coordinate, and 3 parameters for the y coordinate of the POI over the limited time period. The parameters of the model are recovered using a least-squares fitting method that minimizes the equation shown in FIG. 12L. Methods for performing such minimizations are known in the art, and are also described in “Least Squares Regressions with the Bootstrap: A Survey of their Performance” by Jonas Böhmer, Sep. 8, 2009.

FIG. 12M shows the result of such interpolation and extrapolation with the recovered line segments overlaid on a single video frame, in some embodiments. A step in the automatic method is to be able to correct errors in the curve fitting process efficiently, in some embodiment. This is performed using the method shown in FIG. 12H. On a video frame from a first time instant, a user may click at or near a recovered line segment. Processing may be performed within a region of interest, indicated by the rectangle, positioned proximate to the line segment. The processing may include displaying a montage of the video frames within the region of interest from time periods other than the first time instant. In one embodiment the montage may be generated by averaging the pixel intensities from the video frames within the region of interest that is based on the recovered line segment. As a result the position of the POI in many other frames is visible in a single frame, thereby avoiding review of the position of the POI in prior frames, and without confusion of montages of other POIs outside the region of interest. In FIG. 12I, the curve fit of the ball trajectory was incorrect since only the beginning and end points of the ball were designated. In FIG. 12H, the montage of the actual ball location is shown, as well as the computed trajectory of the ball, as indicated by the dotted line within the region of interest. In one embodiment, the user clicks on the correct ball location at the time instant of the frame. The table of recorded positions is modified to include the ball location, and the curve of the ball POI is re-computed using the same method as previously used. The resultant trajectory now more closely matches the actual ball trajectory, as illustrated in FIG. 12O.

In other embodiments, instead of the operator clicking on the ID marker of the POI, alternate methods of assigning the ID and some positional attributes of POIs may include using the GPS location of devices worn by players, or by having the players wear a Bluetooth or RFID tag, the proximity of which is detected and recorded by a Bluetooth sensor and a computer, several of which are positioned around the event. An embodiment of this is shown in FIGS. 12D and 12E. The location, ID tag, and time is automatically uploaded to a server, as described previously.

The position attribute of each POI may be used in a subsequent rendering step of the method to define a region of interest around which a camera view may be synthesized in order to generate a virtual view that highlights the activity of a particular POI, as described in this specification.

In some embodiments, quality metrics are computed and assigned automatically to each POI in each image from each camera view. These metrics may be used during the video production process in order to select automatically which camera view and/or region of interest is preferred at any time instant. One quality metric, pixels-per-meter, of each POI has already been described previously; a large pixels-per-meter metric corresponds to a higher quality metric with respect to the resolution of the POI. In some other embodiments, another quality metric is the speed and/or direction of the POI with respect to each camera view. If the velocity component of the POI in the direction of the camera is towards the camera, then this may have a higher quality metric than if the velocity component of the POI is away from the camera, because a player typically is facing the direction of travel, and the facial view is typically a preferred view in produced video. The velocity component of the POI in the direction of the camera can be computed from the trajectory of the POI computed earlier by taking a difference between points in the trajectory at two adjacent time intervals. For example, FIG. 12P shows player 1 running towards the camera. The trajectory of the user is primarily towards the camera and therefore the quality metric will be higher than if the player was running away from the camera.

In some other embodiments, the quality metric may be based on the detection of the crowd cheering. In some embodiments this may be detected by measuring the amplitude of the audio signal, and by thresholding it so that if the amplitude is above the threshold then it is determined that the crowd is cheering. This may be used in the editing and rendering process as described herein.

In other embodiments, a quality metric may be the determination that a particular team has scored at a particular moment in time using an annotation entered by an operator. In other embodiments, a quality metric may be the determination that a game or portion of a game has started or ended using an annotation entered by an operator. In other embodiments, a quality metric may be the determination that a player is in possession of the ball using a threshold on the distance from the defined ball position and the defined player position.

In some embodiments, the quality measures may be used to determine whether a video source should be used at all to include a POI in an edited product. For example, a POI in a video may not have enough pixels-per-meter to be acceptable for the purpose of the edit. In some other embodiments, if a POI appears in multiple videos at the same time, then the quality measures may be used to choose which video source should be selected for an edited product at any moment in time.

FIG. 12Q shows a graph of quality measures of a single POI over time from two video cameras over a time period. Time is presented on the x-axis. In some embodiments, the selection of the camera view for a POI at any particular time may be determined by choosing the maximum value of the quality measures determined from a plurality of camera views. FIG. 12Q on the bottom shows the resulting camera viewpoint selected at any given time period. Note that the camera number rapidly changes, particularly at the point where the quality metrics are close to each other in value. In some embodiments, this may result in very rapid switching of the scene in the produced video, which may be undesired. In some embodiments of the method, hysteresis is applied at least either to the quality metric over time or the selected camera viewpoint over time. In some embodiments, the hysteresis may be applied to the difference between the maximum quality metric and the next largest quality metric, such that once a camera view has been determined, a large difference in quality metric is required to change the determination of the camera view. In some other embodiments, a temporal filter is performed on the sequence of scene selections. The temporal filter may prevent switching of scenes in a time period. The filter may be implemented by treating the sequence of selected camera views as a signal, and by performing a morphological dilation and/or erosion of the sequence. An example implementation of such an algorithm is in “Image Analysis and Mathematical Morphology, Volume 1” by Jean Serra. FIG. 12R on the bottom shows the result of such processing. There is now only one single transition between the selected camera viewpoint and the next. Hysteresis and temporal filters may be used on all other quality metrics in similar ways.

In some embodiments, one or more video edits are rendered using information that may include the positions of the POIs and their attributes. In cases where the POI is detected only briefly in a video sequence, then in some embodiments a time expansion is applied at or around the recorded time of the detection of the POI to determine the portion of the video to be used in a video edit. For example, in FIG. 12E where a marathon runner is running past a mile counter, if a POI is detected at time t=20, then a time expansion may be applied such that the portion of video to be used in a video edit may be t=20+−10, such video from T=10 to T=30 is used. The time expansion method enables a POI to be observed arriving into the scene and departing from the scene. In some embodiments, the time expansion may be based on the estimated speed of the POI in the field of view of the camera, or the expected time that the POI may be in the field of view of the camera. For example, the speed of a marathon runner is known a priori approximately from the average speed of a runner.

In some other embodiments, a spatial subset of the source video may be used in a video edit. Even if the video camera used to acquire the source video is fixed, then synthetically selecting and moving the position and size of the subset of the source video may simulate the pan/tilt/zoom of cameras that are traditionally used to follow POIs in edited productions. In some embodiments, the subset of the source video is determined from the position of the POI in the image at each frame as defined by the recovered trajectory (or spatial path). The means of recovering the trajectory of a POI were described earlier. The coordinates of a region at or around the center of the POI may be computed as shown in FIG. 12S. FIG. 12S shows an example where the virtual path includes regions that are outside the field of view of the real camera causing areas where no pixels are rendered. FIG. 12T shows an additional example where the virtual camera trajectory changes rapidly at two points of time. In some embodiments, the trajectory of the POI is processed to be consistent with the mechanical properties of a real camera, and to be consistent with the quality expected of a high-quality video production. In some embodiments, the method ensures that the parameters of the trajectory are such that the selected regions of interest are contained within the actual camera view. In some embodiments, the method also ensures that the trajectory of the virtual camera is consistent with a trajectory consistent with the mechanical inertia of a real camera. In some embodiments, this constraint is imposed by setting a threshold on the maximum acceleration of the camera trajectory in each of the x and y dimensions. In some embodiments, this constraint is also imposed by setting a threshold on the maximum velocity of the camera trajectory in each of the x and y dimensions. FIG. 12U shows one embodiment of a method for computing the y component of the trajectory subject to these constraints. The x component of the trajectory may be computed in the same way. In one embodiment, the method may use the Karush-Kuhn-Tucker (KKT) method that enables minimization of an equation subject to inequality constraints.

The least squares equation for the trajectory in the first and second row of FIG. 12U is formulated in the same way as was shown in FIG. 12L. The third row of FIG. 12U shows 5 sets of 2 equations (10 total), each set of 2 equations imposing the constraint that the y coordinate of the computed trajectory is such that the vertical extent of the region of interest (h in FIG. 12V) is contained within the vertical extent of the real camera view (H in FIG. 12V), in all 5 frames of a sequence.

The fourth row of FIG. 12V shows 1 set of 2 equations that imposes the constraint that the absolute value of the acceleration of the vertical camera position, modeled by the second derivative of the synthetic position of the virtual camera, does not exceed a threshold. In the same way, limits can be imposed on the magnitude of the velocity of the camera.

FIG. 12V shows the result of this embodiment. Note that the chosen virtual views are fully contained within the real camera view, and there are no sudden jumps in the camera trajectory. In a related embodiment, the method above can be used with a pan/tilt/zoom camera rather than a fixed camera, when the term “real camera view” is re-defined to mean “bounding camera view” or “bounding scene/region of interest”. A pan/tilt/zoom camera has the advantage of being able to zoom in more and can point at more areas of the scene compared to a fixed camera. Just as the “real camera view” in the description above is the limit of what areas in the physical scene can be acquired with a fixed camera, the “bounding camera view” is the limit of what areas in the physical scene can be acquired by either of a pan/tilt/zoom camera or a fixed camera. For example, the bounding camera view at a sports event typically includes the playing surface and also the area in which the audience is sitting. It typically would not include the sky or ceiling since these are of no interest to the viewer, and it is advantageous to prevent an unskilled operator inadvertently pointing the camera to such locations. Given a bounding camera view, then just as in the case of a fixed camera, the black areas in FIG. 12S show in the case of a pan/tilt/zoom camera areas of the scene captured outside the bounding camera view. FIG. 20 shows, just as in the case with a fixed camera, shows for the case of a pan/tilt/zoom camera the discontinuous path of a camera trajectory contained within the bounding camera view. FIG. 12V, just as in the case with a fixed camera, shows for the case of a pan/tilt/zoom camera a continuous and smooth path of the camera view within the bounding region of interest, using the same method described above for a fixed camera, except instead of virtual pan/tilt/zooming of the camera view, physical pan/tilt/zooming of the camera is performed.

In another example, FIG. 12W shows the resultant virtual views at different times for player 7 moving on the basketball court. In some embodiments, the size of the region may be fixed and pre-entered by an operator. In some other embodiments, a quality metric, such as pixels-per-meter, may be used to dynamically adjust the size of the region based on the 3D size of the POI. For example, if the POI is moving away from the camera, then the pixels-per-meter quality metric will reduce. In some embodiments, the size of the region may be based on the pixels-per-meter quality metric, such that the synthetically-generated camera field of view appears to zoom in as a POI moves further from the camera. A produced video typically requires that each frame in the sequence has the same number of pixels in the horizontal and vertical direction. An image warp process, for example “Nonaliasing Real-Time Spatial Transform” by Karl M. Fant, IEEE Computer Graphics and Applications v6n1, January 1986, may be used to map a variable sized region of interest onto a uniformly-sized region of interest. In the process of this mapping, small regions of interest will be zoomed up to occupy the size required in the uniformly-sized region of interest used in the produced video.

As discussed previously, one or more quality metrics of each POI computed for each camera view may be used to determine the view used in an edited video at any recorded moment in time. In an example, FIG. 12H shows player 7 (the player on the right) running away from camera C1 so that in the fifth frame of the sequence is far from the camera. FIG. 12I shows player 7 at the same time instant from a different camera C4 positioned on the other side of the court. In this case the quality metric for player 7 from camera C4 at this particular time instant may be computed to be higher than the quality metric computed in C1 because, for example, the computed pixels-per-meter value is higher for player 7 from camera C4 at that time instant.

FIG. 12Y shows the sequence of images from an example of a produced video using the method described. The first 4 images are cut out regions from camera C1 following the trajectory of player 7 while at the same maintaining constraints consistent with a real camera as previously described. The 5^{th} image is from camera C4 on the opposite side of the court, since the method determined that this gives a view of the POI with a higher pixels-per-meter quality metric.

In some embodiments, a high quality measure of a particular type measured from a first camera view or sensor can trigger an edited view from a second camera view. For example if an audio sensor detects the audience cheering as described earlier, then the edited view may switch to a region of interest in a second camera view that has been pre-defined by an operator to include the audience.

In some other embodiments, the system uses the determination that a game or portion of game has started or ended to control the edit by performing a virtual pan/tilt/zoom of a camera when the game is not in progress to introduce synthetic camera motion and to retain the attention of the viewer until the game begins again.

In some other embodiments, if a player is designated as just having received a ball, then the edit may switch to display the player at a larger pixels-per-meter rate from the same camera view, or display the player from a second camera view for a predetermined period of time.

In some other embodiments, hysteresis is introduced into the synthetic camera pan/tilt/zoom position such that the synthetic camera position does not move unless the player or ball or other region of interest moves by more than a predefined percentage of a dimension of the camera field of view. This prevents small-amplitude movements in the camera that are distracting while still maintaining relevant action in the field of view of the virtual camera.

In some other embodiments, if it is determined that a particular player has possession of the ball, then the synthetic view is chosen to be spatially biased to view more of the game area in which is predicted the player will move. This is performed by determining from the player ID which target goal in which the team is aiming to score. The positions of the goals in a camera field of view are pre-defined by an operator. A synthetic view is then chosen to be centered at or near a point between the position of the player and the position of the target goal. This bias in chosen viewpoint increases video coverage of defensive action in the game in response to offensive player movements.

In another embodiment, a random element is introduced into the view synthesis rule structure such that a random view synthesis is chosen out of a selected set of acceptable preferred views. This adds some variety to the edited video and avoids repetitive scene transitions.

In another embodiment, a random component is added to the position of the synthesized camera motion. This adds some variability into the position of the camera to simulate the camera motion that would occur if the viewing position of the camera was controlled by a human.

In another embodiment, a motion blur filter is performed on the synthesized view in the direction of the velocity of the synthesized camera view. This is to simulate motion blur that would occur in a real camera introduced by image integration over several camera pixels in the direction of camera motion. The rendering process can be performed using quality metrics computed for any number of POIs from any number of source videos. Therefore different, unique edited videos may be produced for each POI. In addition, as different rules are applied to the quality metrics, then different produced videos may be generated for a single POI, each produced video focusing automatically on different aspects of the POI, for example focusing on shots taken or on shots defended.

In another embodiment, a log is generated that stores the identity of the source of a video clip used in an edited result, along with at least the duration of the video clip used in the edited result. This can be used for accreditation of a video provider for the video clip used in the produced video.

In one embodiment, a video processor (e.g., of a video production system) includes a video input module and a video output module, and is connected to a user interface module such as a mouse or joystick and a display module such as a computer screen. The video output module is capable of producing images successively at a periodic interval. The user interface module may be a computer mouse, joystick or other input device, and the user may click aperiodically on the input video frames that are presented to the user by means of the display module. As views of different scenes from the input video are presented to the user, the user may click aperiodically on a particular location, or a point of interest (POI). For example, a POI may be the location of a ball in a sports event. The user may be unskilled in the art of broadcasting, and this means that while the user may provide general input on where the activity is, the user may be unable to adhere to standards or achieve quality metrics that in some embodiments define acceptable video for broadcasting purposes. In addition, since the output module produces images successively at a periodic interval at a rapid rate, typically at 25 Hz or 30 Hz (frames per second), the user is physically incapable of providing input of any type for each frame at that rate. The user therefore can only provide input on only a subset of the image frames presented to the user. The POI identified by the user input can be used to define a region of interest (ROI) for inclusion in the output images. The specific ROI is the result of processing as described herein, but in an example output of the processing, the ROI may be an area surrounding the POI, with the POI being close to the center of the ROI.

Different users may identify different POIs even if the input imagery is the same. For example, a first user may click aperiodically on a first player as a POI, while a second user may click aperiodically on a second player as a POI. Alternatively, if the input video is from a recorded video stream, then the same first user may click on a first player as a POI in one pass of the input video, and then may rewind the input video and then may click on the second player as a POI in a second pass of the input video for instance.

In some embodiments the user or video production system may pre-define a bounding scene of interest (BSI) representing a predetermined extent of a field of view of a corresponding camera, and such that the area outside the BSI is undesirable for image frame acquisition. For example, in the case of a fixed or static high resolution 4K pixel camera, the BSI may be the full extent of the acquired image. In other embodiments, it may be a rectangular region of interest that does not include the sky and only includes the sports arena. The BSI provides information to the processing, described later, that will be used to constrain the scene regions from where the regions of interest (ROI) for the produced video images is selected, in order to satisfy one aspect of producing high quality video. For example, in the case again of a fixed high resolution 4K pixel camera, in one embodiment one aspect of producing high quality video is that the region of interest is fully contained within the 4K pixel camera view, and does not include areas that lie outside this area, since those areas have no pixel values and therefore may be output as black, or some other synthetic set of pixel values that do not correspond to the real scene, and that are therefore poor quality and undesirable in terms of the production of broadcast video.

In another embodiment and for the case of a pan/tilt/zoom (or real) camera, the physical camera is typically capable of being pointed at a very wide area of the scene. The desired BSI in this case may be the region of the pitch (e.g., playing field) of a sports event, which is only a subset of the region where the pan/tilt/zoom camera can be physically pointed.

The BSI may be defined, in the case of a fixed camera, by the user defining by means of a mouse, a rectangular box within the field of view of the fixed camera. In some embodiments the rectangular box may be the same as the field of view of the camera. In the case of a pan/tilt/zoom camera that supports spatial pan, spatial tilt and/or optical zoom functions, the BSI may be defined by the user pointing the camera at each of: the top left, top right, bottom left, bottom right of the scene that is of interest, and the pan/tilt angular coordinates of the camera at each of the 4 points are read and stored in a configuration file to define the BSI. During subsequent processing, the pan/tilt angular coordinates can be read and the position of the camera with respect to the boundaries of the BSI can be computed by taking the difference between the current angular coordinates and the stored angular coordinates.

In some embodiments, the BSI may comprise two BSI's cascaded together. For example, a high resolution 4K camera may be mounted on a pan/tilt/zoom mount. A first BSI may be defined by the 4K camera view. A second BSI may be defined by the view provided by changing the pan/tilt/zoom camera mount. This cascading of BSIs to effect a single BSI may be useful in some embodiments since in the first BSI (from the 4K camera view), all pixels in the BSI are captured such that any output ROI at any time instant, either forwards or backwards, can be selected as a result of the processing. In the second BSI (due to the pan/tilt/zoom mount) only some pixels in the BSI are captured, so that only some ROIs at a particular time instant can be selected. The second BSI is however potentially much larger than the first BSI due to the pan/tilt/mount. In some embodiments, by cascading both BSIs into a single BSI, in some embodiments compared to a single BSI there is the advantage of a larger combined BSI together with a larger ability to select ROIs from more time instants, both backwards and forwards.

The processing dynamically adjusts the field of view of the camera for image frame acquisition, to steer subsequently acquired image frames and corresponding scenes for the video to be contained within the BSI, and such that the scenes are arranged successively at a periodic interval, even if the user input is aperiodic as described earlier. In some embodiments, the camera view within the BSI can be defined as a virtual camera that uses digital pan, tilt and/or zoom functions to identify portions of high definition source images to be extracted as the image frames, and the BSI corresponds to image boundaries of the high definition source images. In some embodiments, the dynamic adjustment performed by the processor dynamically adjusts the field of view of the camera view to provide a smooth spatial transition of corresponding elements across the scene of the video. For example, even if the user clicks the mouse at the top of the BSI, then the bottom of the BSI and then the top of the BSI again, the processing would smooth the spatial transition of the output regions of interest so that the motion trajectory of the output video appears smooth even if the motion trajectory from the user input is not smooth. In some embodiments, high quality broadcast video should appear smooth. The particular methods for smoothing the camera trajectory while at the same time identifying ROIs of other image frames for inclusion as scenes in the video are described in more detail herein. However the methods may include interpolating and/or extrapolation methods, whereby the sparse and aperiodic mouse click positions inputted by the user are in some embodiments processed to achieve one or more of three objectives simultaneously: a) identify an ROI that would comprise an output image frame at a periodic rate, b) ensure that each ROI is within the BSI, and c) ensure that the spatial trajectory formed by the ROI over multiple output images is smooth. This ensures that the quality of the output video is suitable for broadcasting, at least with respect to the aforementioned factors.

In some other embodiments, additional quality metrics are also computed in order to optimize the quality of the output video with respect to other factors. In one embodiment, a quality metric for each of the image frames comprises a pixel resolution of a reference POI in each of the corresponding image frames. As described later, the reference POI may be computed by modeling the scene, such that, for example, if a POI selected by the user is at a far end of a playing field with respect to the camera position, then the pixel resolution can be computed to be lower compared to the pixel resolution computed if the user had selected a position at the near end of the playing field. This process can be repeated using multiple cameras that may be positioned at different locations around a playing field. A user may click on a POI in one camera, and using the 3D model, a resolution quality metric can be computed. Using the 3D model, the same POI from the perspective of the second camera and having the same temporal position coordinate is automatically computed. A second resolution quality metric is then computed using that resolution quality metric. In some embodiments, the processing then selects as an output image the image from the first camera if the quality metric of the first image frame is better than that of the second image frame from the second camera. In a specific illustrative example of an embodiment, a first camera may be at one end of a baseball court, and a second camera may be at the other end of the court. The user may click only on images from the first camera. As activity moves further from the first camera, the user may click on regions that are also further away from the first camera such that the computed quality metric from the first camera lowers while the computed quality metric for the second camera increases. As the POI moves to approximately half way across the court, the quality metric for the second camera may be computed to be greater than the quality metric for the first camera. In some embodiments the output video is then controlled to switch from images from the first camera to images from the second camera so that objects that are closer and therefore are at a higher resolution are shown.

In some embodiments, a quality metric may be one of a speed or direction of a reference POI. For example, the direction of a POI may be the direction that a player or subject in the image is looking. In some embodiments, the detection of a face in a first camera view may determine that the player or subject is looking towards the camera and a quality metric may be defined to be high, whereas the inability to detect a face may determine that the player or subject is looking away from the camera and a quality metric may be defined to be low. As described previously, this quality metric can be computed on one or more camera views and in some embodiments the output imagery is selected from the camera views with the highest quality. In an illustrative example, if a player runs up the court facing a camera, then the output imagery would show the face of the player from a first camera view. If the player then runs in the opposite direction then the output imagery would be selected to also show the face of the player but this time from the second camera view. In this illustrative example, it is preferred in high quality broadcast video to show faces of players, as opposed to the backs of their heads.

In a related embodiment, the one or more quality metrics computed as described above may be subjected to hysteresis-based selection of a first image over a second image by adjusting a threshold or trigger for selecting the first image over the second image. To illustrate the purpose of the hysteresis-based selection in one embodiment, consider a player on the court that the user defines as an ROI. If the player is moving back and forth in the vicinity of the half-court position with a camera on either end of the court. The quality metric (computed by detecting the pixel resolution as described previously) would be very similar for each camera view such that the highest quality metric would switch rapidly from one camera view to the next, and if the raw quality metric is used to control the camera view, then the output imagery would also rapidly switch from one camera view to the next. In high quality video however, rapid switching between camera views is undesirable. In the embodiment, the problem is alleviated by use of hysteresis-based selection. In this method, the difference in quality metric has to exceed a threshold or trigger value before the current camera output is allowed to switch to a different camera output. In this way, rapid switching between camera views is eliminated.

In some embodiments, the user may designate an incorrect POI by mistake, such that the generated spatial path of the ROI is also incorrect. In some embodiments, the user interface may have a correction button that allows the user to specify a correction by modifying or deleting a POI, after which the generated spatial path of the ROI is updated using the modified set of current and previously-entered POIs.

Referring to FIG. 12Z, one embodiment of a method for improving quality in video production is depicted. In brief overview, image frames for use in producing a video is presented to a user on a display of a video production device (1201). The video being produced is to have scenes arranged successively at a periodic interval, each of the presented image frames corresponding to a separate scene. A video processor may receive, via a user interface of the video production device, inputs from the user for only a subset of the image frames (1203). Each of the inputs may indicate a point of interest (POI) in a corresponding image frame. The POI may be indicative of a region of interest (ROI) for inclusion as a scene in the video. The video processor may evaluate a spatial path of the indicated POIs relative to a bounding scene of interest (BSI) (1205). The BSI may represent a predetermined extent of a field of view of a corresponding camera for image frame acquisition. The video processor may dynamically adjust, in response to the evaluation, the field of view of the camera for image frame acquisition, to steer subsequently acquired image frames and corresponding scenes for the video to be contained within the BSI (1207). The video processor may produce, in accordance with the dynamic adjustment, the video with all scenes arranged successively at the periodic interval (1209).

Referring to (1201), and in some embodiments, image frames for use in producing a video is presented to a user on a display of a video production device. The video being produced is to have scenes arranged successively at a periodic interval, each of the presented image frames corresponding to a separate scene. The image frames may be presented in temporal sequence or in any sequence, e.g., as determined by the user. In some embodiments, the image frames are acquired via two or more cameras and/or two or more viewpoints. Some of the image frames may correspond to a same temporal position coordinate (e.g., acquired at the same instant in time), and may offer alternative viewpoints of a POI for instance, for selection to include in the video being produced.

In some embodiments, the images frames may be presented to the user as a live feed or in real time, or near real time. In some embodiments, the images frames are pre-recorded images (e.g., retrieved from storage) and are played back or otherwise presented as an input video to the user. Multiple ones of the image frames (or scenes) may be presented to the user at the same time (e.g., on the same display screen or multiple display screens) or sequentially. The user may have control over the speed at which the image frames are presented to the user, and may apply video playback or trick mode control (e.g., pause, reverse, fast forward, slow advance) over the presentation of the image frames.

Referring to (1203), and in some embodiments, a video processor may receive, via a user interface of the video production device, inputs from the user for only a subset of the image frames. Each of the inputs may indicate a point of interest (POI) in a corresponding image frame. For instance, as views of different scenes from the input video are presented to the user, the user may click aperiodically on a particular location, or a POI (e.g., a player or a ball). The user may select one or more POIs within certain image frames. For example, the user may sparsely, sporadically, aperiodically, asynchronously and/or randomly select one or more POIs on only a subset of the image frames, because the associated frame rate may be faster than the user's selection speed/rate. In some embodiments, the user inputs/selections/clicks are meant to guide scene selection for video production, to be extrapolated and/or interpolated to other image frames not addressed by the user. In some embodiments, the user interface may incorporate mouse, joystick, touch pad, touch screen or other selection/click functions.

The POI selected or indicated by the user input may be indicative of a region of interest (ROI) for inclusion as a scene in the video. In some embodiments, the selected POI defines a region or portion of a corresponding image frame, to be included as a scene in the produced video. For example, the video production system may define an image area around and/or including the selected POI, as a scene to be included in the video to be produced. Different users may click on different POIs and/or different subsets of the image frames, and result in different produced videos.

Referring to (1205), and in some embodiments, the video processor may evaluate a spatial path of the indicated POIs relative to a bounding scene of interest (BSI). The video processor may connect the POIs across various image frames, or determine a curve/path of best fit, to generate the spatial path. The video processor may generate the spatial path by at least one of interpolating or extrapolating from the indicated POIs. The video processor may dynamically generate a new spatial path or update an existing path as new user input(s) are received.

The BSI may represent a predetermined extent of a field of view of a corresponding camera for image frame acquisition. In some embodiments, the BSI is determined based on the context of the camera. In some embodiments, the camera corresponds to a real camera, e.g., that supports spatial pan, spatial tilt and/or optical zoom functions. Such a camera may be referred to as a pan/tilt/zoom camera, and may comprise any mounted or handheld camera. For instance, the camera may be mounted to a pole, wall or other structure, and can be adjusted to perform spatial pan, spatial tilt and/or optical zoom functions. Here, the BSI is at least in part defined or limited by capabilities of the spatial pan, spatial tilt and/or optical zoom functions. For example, the extent of spatial pan, spatial tilt and/or optical zoom by the camera may limit the extent of the camera's field of view for image frame acquisition. In some embodiments, the BSI is at least in part defined by a portion of a scene determined to be undesirable for image frame acquisition. For example, the portion of the scene may include a visual obstacle, blockage or barrier such as a light pole or structural column. In some cases, the portion of the scene may be determined to be undesirable because the portion includes a visual blight such as a trash can, a construction site, or a damaged or vandalized structure.

In some embodiments, the camera corresponds to a virtual camera that uses digital pan, tilt and/or zoom functions to identify portions of high definition source images to be extracted as the image frames. The temporal positional coordinate of such an extracted image frame may correspond to that of the underlying high definition source image. The BSI may correspond to image boundaries of the high definition source images. The high definition source images may be acquired by a real camera, e.g., a static camera or a pan/tilt/zoom camera. In certain embodiments, the camera comprises a hybrid camera that supports spatial pan, spatial tilt, optical zoom, digital pan, digital tilt and/or digital zoom functions, and the BSI is at least in part defined by capabilities of the spatial pan, spatial tilt and/or optical zoom functions. For instance, the hybrid camera may incorporate a virtual camera with further access to spatial pan, spatial tilt and/or optical zoom functions of the associated real camera.

Referring to (1207), and in some embodiments, the video processor may dynamically adjust, in response to the evaluation, the field of view of the camera for image frame acquisition, to steer subsequently acquired image frames and corresponding scenes for the video to be contained within the BSI. Since it may not be possible or desirable to acquire imagery beyond the BSI, a given spatial path or trajectory of a POI can be used to predict if the corresponding scenes are expected to extend beyond the BSI, and to trigger adjustments to the video being produced. The video processor may generate the spatial path and evaluate the spatial path with respect to the BSI. The video processor may determine the proximity/distance and/or speed of approach of the spatial path relative to the BSI. The video processor may dynamically adjust, in response to the determination or evaluation, the field of view of the camera for image frame acquisition, to steer subsequently acquired image frames and corresponding scenes for the video to be contained within the BSI. For example, the video processor may adjust or shift a ROI relative to a POI, to contain the ROI within the BSI.

In some embodiments, the video processor adjusts according to the spatial trajectory, one or more of the ROIs of the subset of image frames, for inclusion as one or more scenes in the video. The video processor may dynamically adjust the field of view of the camera for image frame acquisition to provide smooth spatial transition of corresponding elements across the scenes of the video. For instance, the video processor may gradually adjust or shift ROIs relative to POIs, to contain the ROIs within the BSI, and to ensure a smooth transition between the ROIs or scenes in the produced video.

In certain embodiments, the video processor receives, via the user interface, an input from the user specifying a correction to a position of a first POI in the generated spatial path. For instance, the user may click on a different POI or location of an image frame, from one identified earlier, as a corrective action. The video processor may update, responsive to the correction (or corrective action), one or more ROIs for inclusion as scenes in the video. For example, the video processor may update the spatial path based on the correction, and may update or replace one or more ROIs for inclusion as scenes in the video.

In some embodiments, the video processor determines a quality metric for each of the image frames. In some embodiments, the video processor selects a first image frame acquired using the first video camera over a second image frame acquired using the second video camera and having a same temporal position coordinate as the first image frame, to use in the video, responsive to determining that the quality metric of the first image frame is better than that of the second image frame. The quality metric may comprise a pixel resolution of a reference POI in each of the corresponding image frames. A first number of the image frames may be acquired using a first video camera and a second number of the image frames may be acquired using a second video camera. The video processor may determine that the quality metric of a first image frame is better than that of a second image frame. The video processor may select the first image frame acquired using the first video camera over the second image frame acquired using the second video camera and having a same temporal position coordinate as the first image frame, to use in the video, responsive to determining that the quality metric of the first image frame is better than that of the second image frame.

In some embodiments, the video processor determines a quality metric for each of the image frames according to at least one of a speed or direction of a reference POI with respect to a corresponding camera viewpoint. A first number of the image frames may be acquired using a first video camera and a second number of the image frames may be acquired using a second video camera. The video processor may determine that the quality metric of a first image frame is better than that of a second image frame. For instance, the quality metric of a first image frame may be better because the POI in the first image frame has been identified as a key element/character of the video being produced, because the POI is facing, approaching, and/or accelerating towards the camera.

The video processor may perform hysteresis-based selection of a first image frame over a second image frame having a same temporal position coordinate as the first image frame, to use in the video, by adjusting a threshold or trigger for selecting the first image frame over the second image frame. The video processor may select a first image frame over a second image frame according to a temporal or other filter. The video processor may select a first image frame over a second image frame according to a threshold or trigger set by the user for instance.

In some embodiments, the video processor determines at least a first quality metric for a first POI or a second quality metric for a second POI, for each of the image frames. The video processor may select a first image frame over a second image frame having a same temporal position coordinate as the first image frame, to use in the video, responsive to determining that the at least a first quality metric for a first POI and a second quality metric for a second POI of the first image frame, is better than that of the second image frame.

Referring to (1209), and in some embodiments, the video processor may produce, in accordance with the dynamic adjustment, the video with all scenes arranged successively at the periodic interval. The video processor may perform at least one of interpolating or extrapolating, using the POIs of the subset of image frames, to identify ROIs of other image frames for inclusion as scenes in the video.

Each of the elements, modules, submodules or entities, referenced herein in connection with any embodiment of the present systems or devices, is implemented in hardware, or a combination of hardware and software. For instance, each of these elements, modules, submodules or entities can include any application, program, library, script, task, service, process or any type and form of executable instructions executing on hardware of the respective system. The hardware includes circuitry such as one or more processors, for example.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

We claim:

1. A method for improving quality in video production, the method comprising:
presenting, to a user on a display of a video production device, image frames for use in producing a video, wherein the video being produced is to have scenes arranged successively at a periodic interval, each of the presented image frames corresponding to a separate scene;
receiving, via a user interface of the video production device, inputs from the user for only a subset of the image frames, each of the inputs indicating a point of interest (POI) in a corresponding image frame, the POI indicative of a region of interest (ROI) for inclusion as a scene in the video;
evaluating, by a video processor of the video production device, a spatial path of the indicated POIs relative to a bounding scene of interest (BSI), the BSI representing a predetermined extent of a field of view of a corresponding camera for image frame acquisition;
dynamically adjusting, by the video processor in response to the evaluation, the field of view of the camera for image frame acquisition, to steer subsequently acquired image frames and corresponding scenes for the video to be contained within the BSI; and
producing, by the video processor in accordance with the dynamic adjustment, the video with all scenes arranged successively at the periodic interval.

2. The method of claim 1, wherein the camera supports spatial pan, spatial tilt and/or optical zoom functions, and that the BSI is at least in part defined by capabilities of the spatial pan, spatial tilt and/or optical zoom functions.

3. The method of claim 2, wherein the BSI is at least in part defined by a portion of a scene determined to be undesirable for image frame acquisition.

4. The method of claim 1, wherein the camera comprises a virtual camera that uses digital pan, tilt and/or zoom functions to identify portions of high definition source images to be extracted as the image frames, and the BSI corresponds to image boundaries of the high definition source images.

5. The method of claim 1, wherein the camera supports spatial pan, spatial tilt, optical zoom, digital pan, digital tilt and/or digital zoom functions, and the BSI is at least in part defined by capabilities of the spatial pan, spatial tilt and/or optical zoom functions.

6. The method of claim 1, wherein the video processor dynamically adjusts the field of view of the camera for image frame acquisition to provide smooth spatial transition of corresponding elements across the scenes of the video.

7. The method of claim 1, further comprising at least one of interpolating or extrapolating, by the video processor, using the POIs of the subset of image frames, to identify ROIs of other image frames for inclusion as scenes in the video.

8. The method of claim 1, further comprising adjusting, by the video processor according to the spatial trajectory, one or more of the ROIs of the subset of image frames, for inclusion as one or more scenes in the video.

9. The method of claim 1, further comprising:
determining, by the video processor, a quality metric for each of the image frames comprising a pixel resolution of a reference POI in each of the corresponding image frames, wherein a first number of the image frames are acquired using a first video camera and a second number of the image frames are acquired using a second video camera; and
selecting, by the video processor, a first image frame acquired using the first video camera over a second image frame acquired using the second video camera and having a same temporal position coordinate as the first image frame, to use in the video, responsive to determining that the quality metric of the first image frame is better than that of the second image frame.

10. The method of claim 1, further comprising:
determining, by the video processor, a quality metric for each of the image frames according to at least one of a speed or direction of a reference POI with respect to a corresponding camera viewpoint, wherein a first number of the image frames are acquired using a first video camera and a second number of the image frames are acquired using a second video camera; and
selecting, by the video processor, a first image frame acquired using the first video camera over a second image frame acquired using the second video camera and having a same temporal position coordinate as the first image frame, to use in the video, responsive to determining that the quality metric of the first image frame is better than that of the second image frame.

11. The method of claim 1, further comprising performing hysteresis-based selection of a first image frame over a second image frame having a same temporal position coordinate as the first image frame, to use in the video, by adjusting a threshold or trigger for selecting the first image frame over the second image frame.

12. The method of claim 1, further comprising:
generating, by the video processor, the spatial path by at least one of interpolating or extrapolating from the indicated POIs;
receiving, via the user interface, an input from the user specifying a correction to a position of a first POI in the generated spatial path; and
updating, by the video processor responsive to the correction, one or more ROIs for inclusion as scenes in the video.

13. The method of claim 1, further comprising:
determining, by the video processor, at least a first quality metric for a first POI or a second quality metric for a second POI, for each of the image frames; and
selecting, by the video processor, a first image frame over a second image frame having a same temporal position coordinate as the first image frame, to use in the video, responsive to determining that the at least a first quality metric for a first POI and a second quality metric for a second POI of the first image frame, is better than that of the second image frame.

14. A system for improving quality in video production, the system comprising:
a display of a video production device, configured to present to a user image frames for use in producing a video, wherein the video being produced is to have scenes arranged successively at a periodic interval, each of the presented image frames corresponding to a separate scene;
a user interface of the video production device, configured to receive inputs from the user for only a subset of the image frames, each of the inputs indicating a point of interest (POI) in a corresponding image frame, the POI indicative of a region of interest (ROI) for inclusion as a scene in the video; and
a video processor of the video production device, configured to:
evaluate a spatial path of the indicated POIs relative to a bounding scene of interest (BSI), the BSI representing a predetermined extent of a field of view of a corresponding camera for image frame acquisition;
dynamically adjust, in response to the evaluation, the field of view of the camera for image frame acquisition, to steer subsequently acquired image frames and corresponding scenes for the video to be contained within the BSI; and
produce, in accordance with the dynamic adjustment, the video with all scenes arranged successively at the periodic interval.

15. The system of claim 14, wherein the camera is one of:
configured to support spatial pan, spatial tilt and/or optical zoom functions, and that the BSI is at least in part defined by capabilities of the spatial pan, spatial tilt and/or optical zoom functions; or
comprises a virtual camera that is configured to use digital pan, tilt and/or zoom functions to identify portions of high definition source images to be extracted as the image frames, and the BSI corresponds to image boundaries of the high definition source images.

16. The system of claim 14, wherein the video processor is configured to dynamically adjust the field of view of the camera for image frame acquisition to provide smooth spatial transition of corresponding elements across the scenes of the video.

17. The system of claim 14, wherein the video processor is further configured to at least one of interpolate or extrapolate using the POIs of the subset of image frames, to identify ROIs of other image frames for inclusion as scenes in the video.

18. The system of claim 14, wherein the video processor is further configured to:
determine a quality metric for each of the image frames comprising a pixel resolution of a reference POI in each of the corresponding image frames, wherein a first number of the image frames are acquired using a first video camera and a second number of the image frames are acquired using a second video camera; and
select a first image frame acquired using the first video camera over a second image frame acquired using the second video camera and having a same temporal position coordinate as the first image frame, to use in the video, responsive to determining that the quality metric of the first image frame is better than that of the second image frame.

19. The system of claim 14, wherein the video processor is further configured to perform hysteresis-based selection of a first image frame over a second image frame having a same temporal position coordinate as the first image frame, to use in the video, by adjusting a threshold or trigger for selecting the first image frame over the second image frame.

20. The system of claim 14, wherein the video processor is further configured to:
generate the spatial path by at least one of interpolating or extrapolating from the indicated POIs;
receive, via the user interface, an input from the user specifying a correction to a position of a first POI in the generated spatial path; and
update, responsive to the correction, one or more ROIs for inclusion as scenes in the video.
